(19) United States
(12) Patent Application Publication
(10) Pub. No.: US 2022/0027992 A1
(43) Pub. Date: Jan. 27, 2022

(54) NON-FUNGIBLE CRYPTOGRAPHIC TOKENS FOR TRACKING TREES

(71) Applicant: Plants Map, Inc., Spotsylvania, VA (US)

(72) Inventor: Bill Blevins, Spotsylvania, VA (US)

(21) Appl. No.: 17/384,622

(22) Filed: Jul. 23, 2021

Related U.S. Application Data
(60) Provisional application No. 63/055,834, filed on Jul. 23, 2020.

(51) Int. Cl. G06Q 40/04; H04L 9/32; G06F 9/451; G06Q 30/00; G06Q 20/38; G06Q 20/36; G06Q 20/40; G06F 16/81

(52) U.S. Cl. CPC G06Q 40/04; H04L 9/3247; H04L 9/3239; G06F 9/451; G06Q 30/018; G06Q 20/3825; H04L 2209/38; G06Q 20/3678; G06Q 20/389; G06Q 20/4037; G06Q 20/3827; G06Q 20/3674; G06F 16/81; G06Q 20/3829

(57) ABSTRACT

Provided is a process for tracking trees. The process of tracking trees may include one or more of generating a listing of trees, generating digital tokens representing the trees, or performing one or more operations associated with the trees using the digital tokens (e.g., creating a market place for trading digital tokens, trading digital tokens, or computing carbon credits associated with a tree).

### CROSS-REFERENCE TO RELATED APPLICATIONS

The present utility application filing claims the benefit of U.S. Provisional Application No. 63/055,834, filed 23 Jul. 2020, and which bears the title “Non-Fungible, Cryptographic Tokens for Tracking Tees,” the entire contents of each aforementioned patent filing being incorporated by reference herein.

### BACKGROUND

### 1. Field

The present disclosure relates generally to tracking trees and, more specifically, to tracking trees using a distributed ledger.

### 2. Description of the Related Art

Planting trees supports wildlife, improves water quality, mitigates climate change, and affords a variety of other public benefits. Various programs, such as adopt a tree programs, allow individuals or groups to voluntarily contribute funds to preserve or plant trees as a positive and personal step toward preserving and improving the environment. Various online services (e.g., via websites or mobile applications) provide such adopt a tree programs for individuals to contribute funds for adopting a tree.

In some other examples, forest service or other wildlife management programs may incentivize the planting of trees or providing other wildlife habitats on private property, such as by reducing property taxes, providing rebates, or other incentives. Oftentimes, however, the incentives do not cover the full cost of planting trees or otherwise establishing wildlife habitats, and in many cases expire or otherwise do not cover continued maintenance costs.

### SUMMARY

The following is a non-exhaustive listing of some aspects of the present techniques. These and other aspects are described in the following disclosure.

Some aspects include a process for tracking trees. The process of tracking trees can include one or more of generating a listing of trees, generating digital tokens, such as cryptographic tokens, representing the trees, or performing one or more operations associated with the trees using the digital tokens (e.g., creating a marketplace for trading digital tokens, trading digital tokens, or computing carbon credits associated with a tree).

Some aspects include a decentralized computing platform, such as a blockchain-based computing platform, by which example aspects of the above-mentioned process may be implemented.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block logical and physical architecture diagram of a computing environment for tracking trees on a distributed computing platform in accordance with some embodiments of the present techniques;

FIG. 2 is a flowchart of an example of a process executed by an application server and/or a computing node with a smart contract in accordance with some embodiments of the present techniques;

FIG. 3A is a flowchart of an example of a process executed by an application server and/or a computing node with a smart contract in accordance with some embodiments of the present techniques;

FIG. 3B is a flowchart of an example of a process executed by an application server and/or a computing node with a smart contract in accordance with some embodiments of the present techniques; and

FIG. 4 is a block diagram of an example computing device with which the above-described techniques may be implemented in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of tracking trees. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Existing computer systems and techniques for tracking trees are not suitable for certain use cases. For example, many such existing systems have an architecture that leaves a single party in control of the records about trees. As such, investors, donors, etc. must trust that the single party is, and will remain, solvent and trustworthy, because the architecture of the computer system affords a single point of control in all aspects of its records about trees. A malicious actor could, for example, manipulate records in local memory to re-credit the planting or maintenance of trees from one user to another, or change the code relied upon by a userbase to favor the controlling entity. Generally, these architectures fail to provide Byzantine fault tolerance.

Existing databases can provide Byzantine fault tolerance, for instance, with many types of blockchain-based distributed ledgers. However, such systems are generally not suitable for tracking trees in the manner described herein because they do not implement the types of transformations on records about trees described herein and, in some cases, are limited to relatively simple operations of transferring fungible cryptographic tokens from one wallet address to another. Unlike fungible cryptographic tokens, trees are unique, e.g., non-fungible, each (or a collection thereof) having a unique set of attributes relative to another tree (or another collection of different trees). Moreover, attributes of a tree (or a collection thereof) evolve over time (e.g., temporally). For example, associated attributes, like height, age, etc., change over time. Thus, while a tree (or collection thereof) may be uniquely identified, such as by one or more identifiers, it may be desirable to track other properties which change over time with respect to a tree (or collection thereof). Indeed, many such systems lack the infrastructure to address the temporal attributes of trees, which unlike immutable tokens, are planted, grow, consume resources, sequester carbon, and eventually die. Existing blockchain-based computing systems generally have no “model” of a tree that takes one or more temporal attributes (e.g., age and possibly weather, geolocation, or climate, among others) as input parameters upon which to perform computations or take responsive action by which records of trees could be managed.

Some embodiments implement a decentralized application (“application”) by one or more services executing on a decentralized computing platform. Some examples of a decentralized computing platform may be a blockchain-based computing platform (“platform”) for tracking trees or including tree tracking functionality, e.g., implemented with the Ethereum or Hyperledger standards (and standard-compliant corresponding virtual machines, protocols, and data structures), the contents of which are hereby incorporated by reference. The decentralized application may include a service which executes on the platform to generate digital tokens (also referred to as “tree tokens”), such as non-fungible cryptographic tokens (NFT), that represent trees. A tree token generated by the service may correspond to a specific tree (or in some cases a collection of trees) and be provided or issued to an account (e.g., like a wallet address) of a user. In some embodiments, a tree token may be an ERC-721-standard compliant token, said standard being hereby incorporated by reference.

In some example embodiments, such as those examples including ERC-721-standard compliant tokens, or other token standards implementing non-fungible cryptographic tokens, each token of a given type (e.g., tree tokens) may be unique relative to other tokens of the same type. In other words, no two tree tokens utilized by the service may have a same token value (e.g., like a token identifier). In some examples, the service may be implemented by a body of code (e.g., such as a smart contract, or other body of code by which functions of the service are implemented) resident on the platform and associated with an address on the platform by which functions of the service are called. The address (e.g., of a smart contract) by which the service is called (e.g., for execution) to perform one or more functions may uniquely identify the service (e.g., from other services) on the platform. Thus, for example, a smart contract address (e.g., corresponding to the service) and token identifier (e.g., of a tree token) may correspond to a globally unique paring of values on the platform (e.g., because the smart contract address is unique to the service and each tree token utilized within the context of the service has a unique token identifier). In some embodiments, a tree (e.g., a physical tree) tracked by the service may be represented by one or more tree tokens, but each of the tree tokens may be unique (e.g., in some embodiments, no two tree tokens in the platform are the same).

The platform on which one or more services of the application are implemented may be a public or private platform. The application may provide a listing service that allows tree owners to list their trees. The application may provide an online marketplace that allows users to trade tree tokens (e.g., buy or sell tree tokens from/to the tree owner or other users). The tree tokens may be associated with, and operated upon, by one or more functions implemented by executable computer program code of a service (e.g., a smart contract) that may be called on the platform (e.g., by an address of the smart contract). A tree token may have a unique token identifier and comprise (or be associated with) one or more attributes that define various properties and functions of the tree token, such as a value of the tree token in fiat (or fungible cryptographic) currency, geolocation of the tree, type of the tree (e.g., deciduous or non-deciduous), species of the tree, age of the tree, diameter of a trunk of the tree, water consumption rates of the tree, subjective assessment of the beauty of the tree (e.g., a beauty score), maintenance history of the tree (e.g., trimming dates and amounts, fertilizing dates and amounts, watering history, etc.), or an amount received from the sale of the tree token that needs to be distributed to various parties involved in a transaction (e.g., a tree owner, an entity hosting the platform, or a user selling the tree token).

In some embodiments, by buying a tree token associated with a tree from an owner of the tree, a user may adopt the tree, and the owner of the tree may use the amount received from the sale of the tree tokens in managing the tree or planting new trees. In some embodiments, by rewarding a tree token in exchange for making a donation to adopt the tree, the application provides one or more of a virtual ownership of the tree to a user, a real ownership of the tree including the ecological benefits, a real ownership of the rights to claim the ecological benefits as a carbon credit, a real ownership of the tree including the rights to claim a value of the tree if the tree is harvested, or other stake (e.g., access, lumber if harvested, etc.), thereby promoting the adoption of a tree.

Some aspects of the disclosed embodiments may be implemented on one or more server computing devices. For example, different services of the tree tracking application or platform, e.g., registration service, listing service, tokenization service, online marketplace, etc. may all be implemented on one or more servers, or one or more of the different services may be implemented on a distributed computing platform. In some embodiments, some or all of the application server or platform may be implemented in a distributed computing environment (like a decentralized computing environment), e.g., different services of the platform may be implemented on different servers, or in a network of peer nodes. Data (e.g., tree data, transaction data, etc.) may be stored in the same data repository, or in a distributed data repository.

Some aspects of the disclosed embodiments include the use of NFTs to represent a single tree as a receipt for the donation of funding to a tree owner (e.g., individual, group of individuals or an organization) that planted and/or maintains the tree. Some aspects of the disclosed embodiments include the use of NFTs to represent virtual ownership of a single tree. Some aspects of the disclosed embodiments include the use of NFTs to represent virtual fractional ownership of a single tree, for example, multiple users may have a stake in a tree token (e.g., stakes of different users in a tree token may be recorded in one or more records of the data store by a smart contract). In such examples, a user's digital wallet may store an indication of a tree token and a corresponding stake in the token, e.g., 50% or other amount based on the user's proportional ownership. In such cases, a user may sell or trade their stake in the tree token. A user having 100% stake in a tree token may transfer the entire stake in the tree token to another user, or a portion of their stake in the tree token. Some aspects of the disclosed embodiments include the use of NFTs to represent real ownership of the rights to claim the ecological benefits of a single tree as a carbon offset. Some aspects of the disclosed embodiments include the use of NFTs to represent the ownership of a tree including the ecological benefits. Some aspects of the disclosed embodiments include providing the above features for groups of trees, e.g., sections of forestry land. In some embodiments, a section of land may be processed to tokenize a plurality of individual trees within the section, which may be indicated as excluded from the section of land (e.g., when a plurality of other trees which may later be individually represented by respective tree tokens remain within the section). In another example, after a tree has been tokenized, information such as the identities of the parties, tree information and all future actions associated with the tree and with the tree token may be written to the blockchain-based data repository.

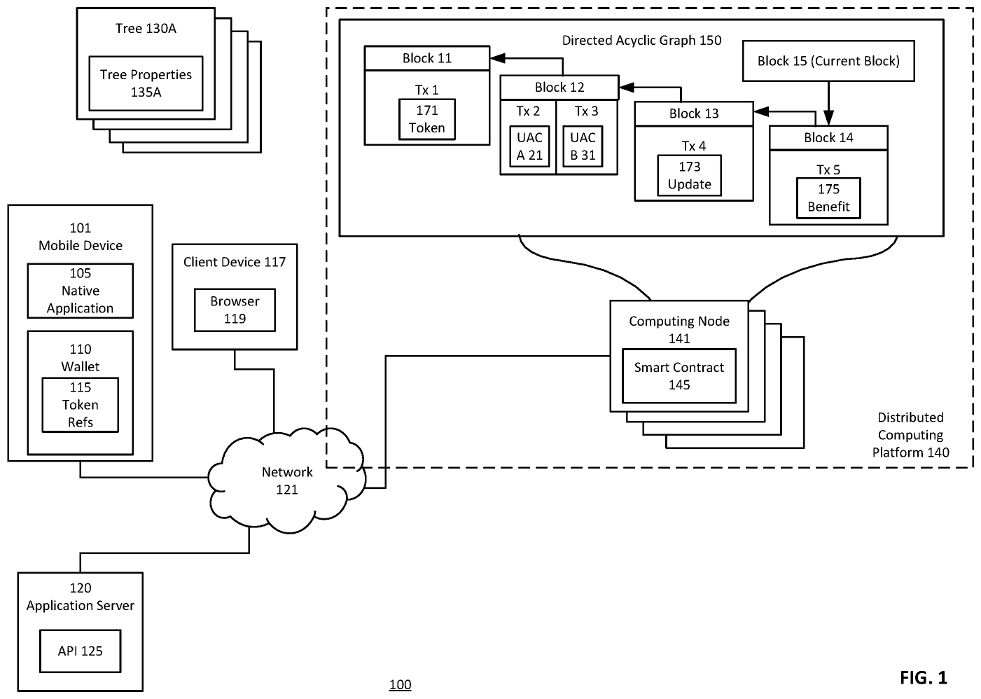

FIG. 1 illustrates an example computing environment 100 within which a tree tracking application and platform may be implemented. In some embodiments, the computing environment 100 may include a mobile device 101, a client device 117, an application server 120, and a distributed computing platform 140 comprising a plurality of computing (e.g., peer) nodes 141. One or more of these components may communicate with one another via a network 121, such as the Internet and various other local area networks. In addition, embodiments of the example computing environment 100 may process information about various trees and their respective properties, such as trees 130 and their respective properties 135.

In some embodiments, the distributed computing platform 140 may be implemented with a decentralized computing architecture, for instance, on a blockchain-based computing platform, like Ethereum, Cardano, NEO, hyperledger, or using a similar blockchain-based protocol. In such embodiments, a tree tokens may be implemented as a non-fungible token (NFT), which is a type of unique cryptographic token that may correspond to a unique asset, such as a tree, and reflects that unique aspect by having an identifier that distinguishes each token from other tokens. NFTs may be tokenized versions of digital or real-world assets. They (or attributes thereof, like ownership) may be stored in records that function as verifiable proofs of authenticity and ownership within a blockchain network, e.g., in tamper-evident records, like directed acyclic graphs 150 of cryptographic hash pointers. NFTs are not interchangeable with each other and introduce scarcity to the digital world.

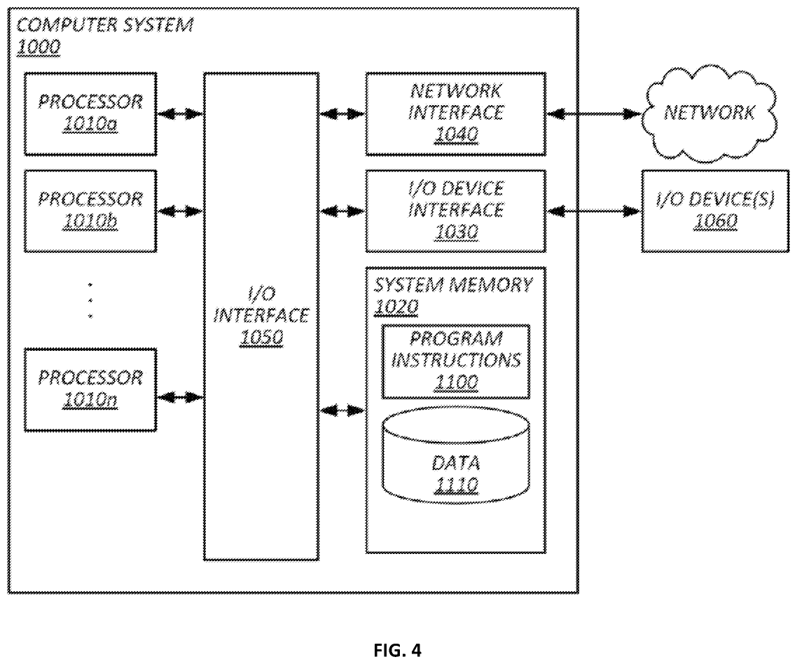

In some embodiments, the platform 140 is executed by virtual machines (e.g., peer-node applications of Ethereum or Hyperledger) executing on a collection of computing devices (e.g., computing nodes 141) like those described with reference to FIG. 4. In some cases, the computing devices 141, respectively executing an instance of a peer-node application, collectively execute each invocation of a smart contract 145 (e.g., comprising a body of computer program code) to determine an output, e.g., based on a consensus output determined with a consensus algorithm, like Paxos, Raft, HotStuff, etc. Some outputs or information indicative of outputs determined by a smart contract, among other data, may be stored within one or more records within a data structure comprising tamper-evident properties, such as a directed acyclic graph 150.

The platform 140 of the computing environment 100 may implement (e.g., via a plurality of participant computing nodes) a decentralized data store, which may be a blockchain-based decentralized data store. Some aspects of the disclosed embodiments may be implemented using a blockchain-based computing platform, like Ethereum, Cardano, NEO, hyperledger, or using a similar blockchain-based protocol. For example, any transaction data associated with selling or purchasing of a tree token (e.g., seller ID, buyer ID, transaction ID, token ID, sale price, etc.) may be stored in a blockchain-based data repository, which is a decentralized data store. For example, FIG. 1 illustrates an example of a decentralized data store as a directed acyclic graph 150. The example directed acyclic graph 150 may include a number of blocks, e.g., blocks 11-15, where each next block references a prior block so as to form a chain of blocks or “blockchain.” Each block may include a number of records (e.g., which may store information about, or correspond to, tree records or tree tokens or transactions involving tree records or tree tokens, or smart contracts 145). Although not shown, records within a block may be stored within one or more nodes. Conceptually, those nodes storing transaction records may be visualized as leaf nodes within a tree-like structure, like a binary tree, or binary Merkle tree (or Radix tree), having a root node and a plurality of intermediate parent nodes, whereby each leaf node may be referenced to the root node via a plurality of references through intermediate parent nodes, or one or more linked lists of nodes. In some embodiments, references are pointers indicative of a location of some data stored within the decentralized data store. In some embodiments, references are associated with a hash, like a cryptographic hash, based on information stored in the node to which the pointer points, to afford a tamper-evident storage scheme. Or other types of cryptographic accumulators may be used for proof of membership. In some embodiments, references are hash pointers, which may be cryptographic hash pointers, and the references themselves may afford a temper-evident storage scheme.

Example computing devices 141 of a platform 140 that includes a collection of computing devices each executing peer compute nodes of a blockchain-based computing platform may host (e.g., a local version of) a blockchain ledger or other tamper-evident decentralized data structure, such as directed acyclic graph 150, upon which determinations made by respective computing nodes may be based. Collectively, the computing devices 141 (e.g., a majority, in accordance with a consensus protocol) may agree on an authoritative version of the graph 150 (or changes thereto) and update local representations thereof. In example embodiments where computing nodes 141 are part of a platform 140 comprising many computing nodes it should be recognized that a computing device participating within the context of the tree tracking system need not communicate with any one specific node. Rather, each may communicate with a different one/multiple of the computing nodes of the platform and also may communicate with different ones of the nodes at different times. Further, in some embodiments, one or more of the application servers 120 may be a computing node or incorporate all or some computing node functionality, thereby operating as part of the decentralized computing platform or configured to communicate with at least some of the nodes (e.g., to submit or retrieve data, not substantially process data).

In some embodiments, computing nodes, like example computing node 141, may operate upon various types of information stored within the decentralized data store of the computing platform 140. Examples include a directed acyclic graph 150 of cryptographic hash pointers, such as a blockchain or other tamper-evident, immutable, decentralized data stores. Other examples include various scripts in a scripting language executable by the computing node 141, for instance with verifiable computing, such that no single computing node 141 needs to be trusted. In some embodiments, these scripts or programs may be referred to as smart contracts 145, a term which should not be confused with a contract or agreement in law, finance, or other similar instrument. Rather, smart contracts 145 refer to programs executable by computing nodes to perform one or more functions, e.g., like an application, with the context of the platform 140 in a consistent manner, and those programs in some cases may be tamper-evident, immutable decentralized programs. A smart contract 145 can be a contract in the sense that the logic of the smart contract is immutable in some implementations once loaded to the decentralized computing platform and thus serves as a form of a commitment to a particular body of logic. As a result, a given smart contract 145 may be executed by any one computing node and execution of that smart contract should provide a same result for given inputs as some other computing node (and thus, in some embodiments, affording verification of that result by one or more (e.g., in a consensus) of the other computing nodes). For example, a smart contract 145 may be stored within the decentralized data store, loaded by a computing node 141 into a memory of the computing node, and executed to perform one or more functions according to the script or program defined by the smart contract. For example, the application server 120 may publish a smart contract 145 to the computing platform such that computing node 141 (among other ones of the nodes) may process information stored in the directed acyclic graph 150, or other information, to perform one or more functions according to one or more operations enumerated in the smart contract 145.

The term “immutable” should not be read to require that immutable data be written to a form of physical media that prevents subsequent writes (e.g., a ROM or write-once optical media). Rather, the term “immutable” refers to a data structure that does not support modifications to data once written. In some cases, this feature is afforded by making the data structure tamper evident, e.g., computationally infeasible to modify committed data without rendering the data structure internally inconsistent. In some cases, the data structure computational infeasibility of undetectable modifications may be afforded by chaining the above-described cryptographic hash values, such that verification of tampering consumes less than 100,000^{th} of the computing resources (e.g., in time or memory complexity) of computing resources needed to modify the data structure to be consistent with a modified previously written record.

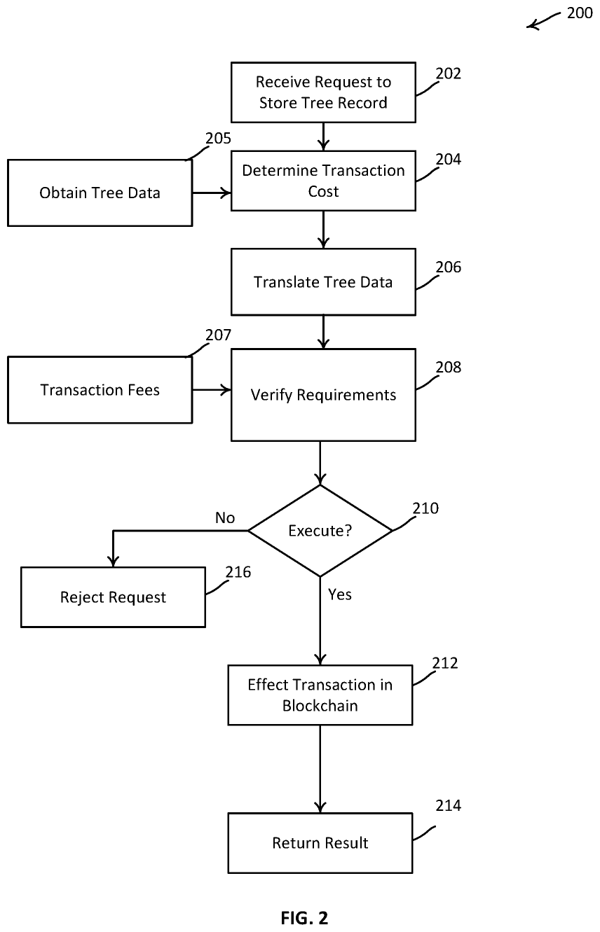

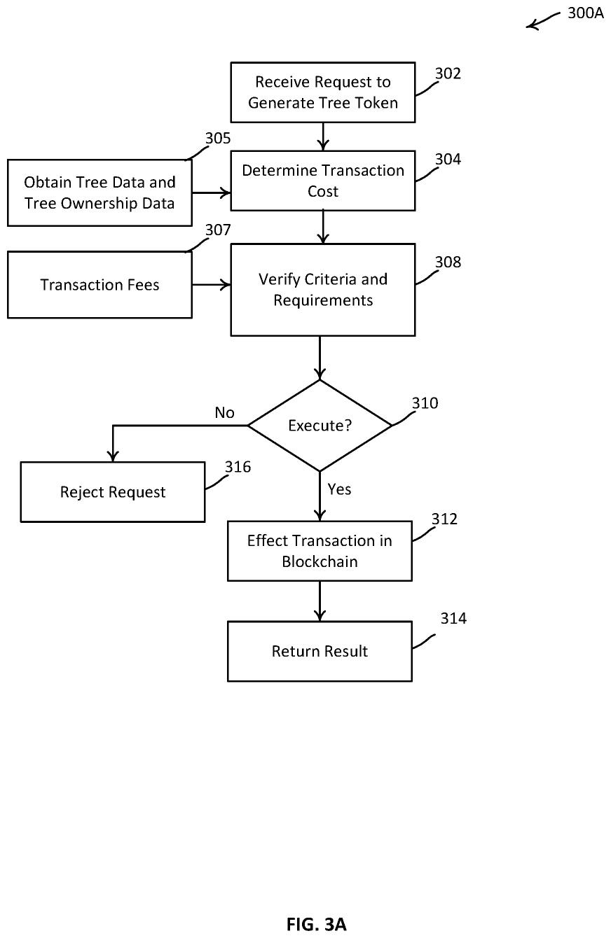

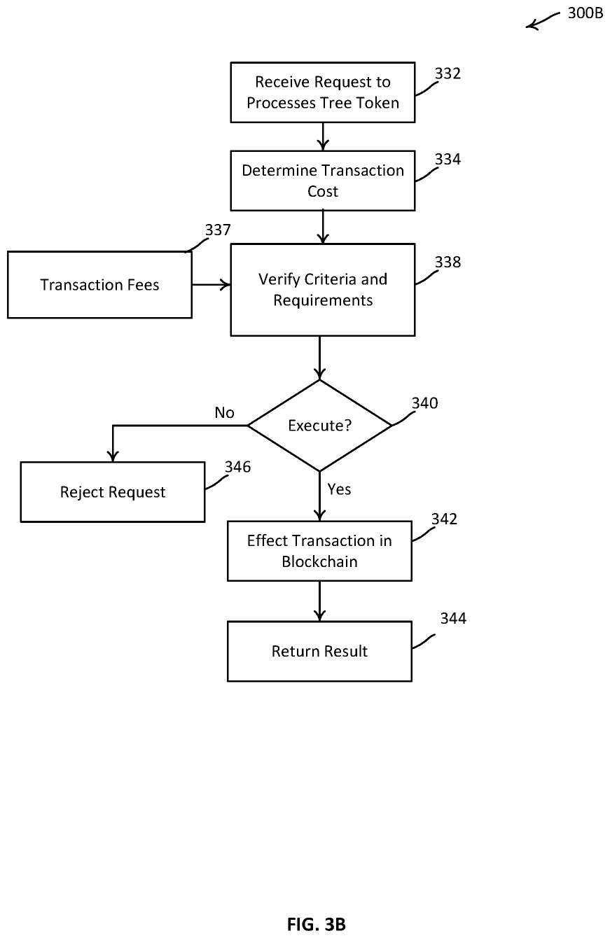

In some embodiments, one or more smart contracts 145 may be stored in the directed acyclic graph 105 or otherwise published to this data repository, or in some cases, the smart contracts may be stored in a different tamper-evident, immutable, decentralized data store from that of the data upon which the smart contracts operate. One example smart contract 145 is shown, but it should be emphasized that there may be, and in some commercial implementations likely will be, multiple instances smart contracts with variations to implement new or different logic. Further, in some cases, the smart contracts may be composed of or reference other smart contracts or invoke or draw upon logic implemented outside of the decentralized computing platform. For example, a smart contract for performing a process like that described with reference to FIG. 2 or FIG. 3 may, in some instances, call to another smart contract or interface with the outside world relative to the decentralized computing platform 140 (e.g., via an application server 130) to obtain (or verify) data upon which one or more functions of the smart contract operate.

In some embodiments, smart contracts, like smart contract 145, may be callable by the various participant entities of the environment 100. Additionally, an application functionality provider, such as the application server 120, may publish new smart contracts that provide application functionality within the context of the platform 140 and are callable by various components or the application server. In some embodiments, the smart contracts may have an address, for instance, in a data storage address space of the platform 140, like an address, such as a cryptographic hash address corresponding to a node or record comprising program code of the respective smart contract. In some embodiments, a smart contract may accept arguments, such as various variables that may be passed to the smart contract and which may be operated upon by logic of the smart contract. Examples of arguments and their variables may include references, like an address, to data within the decentralized computing platform or data for storage within the decentralized computing platform. In some cases, each smart contract may have a respective application program interface with a schema defined in a record of the corresponding smart contract that enumerates arguments that are required, arguments that are optional, default values for arguments, types of those arguments, and the like.

In some embodiments, the peer computing nodes 141 may execute a smart contract 145, for instance, associated with the NFTs (e.g., tree tokens) with verifiable computing techniques, for example, by having each computing node execute the code of the script encoding the smart contract and arriving at a consensus (e.g., with Paxos, HotStuff, or Raft) regarding a result of the execution. In some embodiments, the smart contract may read and write state on the blockchain ledger. In some embodiments, the smart contract (or collection of smart contracts in a call-graph) may further implement logic by which NFT related transactions are implemented. Various functions of a tree tracking application may be supported by one or more smart contracts 145 that may be called for execution by one or more computing nodes 141 of the platform 140 (e.g., to perform one or more of the functions).

In some embodiments, an address of a smart contract 145 may be called with an API call (e.g., to the platform 140, such as to one or more computing nodes 141) including input parameters specified in accordance with the schema of the smart contract. In some embodiments, the computing nodes 141 may respond to the API call by accessing the smart contract specified by the address, optionally verifying the smart contract, executing the smart contract based on the input parameters, and recording the results to the blockchain. This, in some cases, may include calculating a cryptographic hash value based on input parameters (e.g., which may include one or more properties of a tree, documents, images, etc.) or a cryptographic hash value of records in the blockchain. Results may be stored in the blockchain and this process may be repeated for subsequent calls to execute a smart contract 145. For example, a record (e.g., by a Transaction, Tx 1 in block 11) corresponding to generation of a tree token 171, or record of a tree for generation of a tree token 171, may be stored within the blockchain. A generated tree token may be assigned, such as indicated by a transaction Tx 2 in block 12, to a user account A 21, such as a user account A corresponding to a tree owner (e.g., the owner of the tree corresponding to the tree token). The user of user account A 21 may transfer the tree token, such as indicated by a transaction Tx 3, to a user account B 31 (e.g., of another user), thereby conveying possession of the tree token to another user. Information associated with the transactions, which may reference prior records of transactions, may thus indicate a chain of possession of the tree token (e.g., back to its creation), among other data pertaining to the tree token as described herein. Embodiments may interrogate these records to verify authenticity, e.g., by recreating the calculation of the cryptographic hash values along each link in a chain of cryptographic hash pointers and comparing the recalculated values to the values in the chain to confirm (by virtue of matches) that the records are authentic (e.g., to verify current ownership of a tree token by a given user account, information about the tree to which the tree token corresponds, or other information pertaining to the tree token or tree).

In some cases, those transactions may use (e.g., all or some of) the ERC 721 standard (and, in at least some examples, may use one or more additional layers of functionality) for tree tokens, which may be used in transactional exchanges. Tree tokens may be held in a digital wallet of a user, which may be viewed on a user's device or otherwise accessed (e.g., via a website). In some examples, a user may access a wallet 110, either as a standalone application, or component of the native application 105, on their personal user device (such as their mobile phone 101). Each tree token, as outlined above, may be unique, and references to tokens, such as token identifiers, or other information about the respective tokens transferred to a digital wallet of the user may be viewed as assets (e.g., representations of tree tokens or trees corresponding to tree tokens owned by the user account and) tracked within the wallet 110 of the user. Tree tokens may be generated in association with one or more of the transactions described herein to provide representation of trees on the platform 140 and indicate, by way of a user having obtained in their digital wallet a given tree token representative of a given tree, that any privileges or rights associated with ownership of the tree token are conferred to that user.

In some cases, an application may be implemented as a hybrid application. For example, a native application 105 executed by the mobile device 101 (or other device) may communicate with an application server 120. The application 105 may receive user input data and communicate data to the application server 120 via an application programming interface 125 (“API”). The application server 120 may process data, such as based on data received from the application 105 (which may include requesting the processing of data by the distributed computing platform 140), and return results of the processing or determinations based on the results of the processing to the native application 105 via a response of the API 125. The native application 105 may display, store, or otherwise utilize data received from the API 125, such as within the context of one or more user interfaces of the native application 105. Similarly, a client device 117 executing a browser 119 may access a web site, such as a website hosted by the application server 120, which may provide access to functionality of the API 125. A native application 105 or website may also provide user access to functionality (or a subset thereof) provided by the computing platform 140, either through the API 125 or via another API (e.g., corresponding to one or more computing nodes 141, which may include an application server 120 executing a peer-node application). Thus, for example, a user of a mobile device 101 or client device 117 may interact with a native application or web-based interface that interacts with a blockchain-based backend (e.g., the platform 140), such as by invoking execution of a smart contract. Or in some cases, the application may be implemented as a non-decentralized, e.g., monolithic, application.

In some embodiments, the application server 120 may provide a registration service via a native application 105 or website accessible via a browser 119 of a client device 117. The registration service may allow users, such as tree owners or other users interesting in adopting trees by trading tree tokens associated with trees, to register via the application server 120 to utilize the platform 140 for listing trees or trading the tree tokens on the platform. The registration process may involve creation of user accounts for the users. In some embodiments, users may register with the platform, such as by creating an account, like a wallet, associated with the user. In some embodiments, users may register via a native application 105 or via a website associated with the application server 120, which may facilitate the creation of one or more accounts (e.g., a user may have an account with the application server 120 and an account, like a wallet, established on the platform). A user account may be associated with a username and password (or other such credentials), contain user identifiable information (such as name, age, contact information, or occupation), other such information some which is provided by the user during registration process. The registration service may also require the user to submit identification information (e.g., know your customer (KYC) documents) to verify and validate an identity of the user. In some embodiments, certain application functionality (e.g., whether provided via native application 105, website, or smart contract 145) may be prohibited or available to different types of user accounts, or subject to verification of user identify or other qualifications to a certain account type. For example, if a tree owner's identity is not verified, the tree owner may not be allowed to request functionality of a smart contract to generate or sell tree tokens associated with their trees. In another example, if the identity of a user who is interested in buying a tree token is not verified, the user may not be allowed to buy the tree token (and users that are not verified as tree owners may not be allowed to request the generation of tree tokens or sell tree tokens).

In some embodiments, the registration service may include one or more interfaces accessible by users, such as an interface provided via a native application 105 or website accessed by a browser 119, by which a tree owner executes an agreement to participate in an “adopt-a-tree” program (which involves tokenizing a tree to generate tree tokens representing a tree and listing the tree token for trading in online marketplace of the platform and receiving funds from the trading of the tree tokens, which may be used in managing the tree or planting additional trees). In some examples, such as after registration as a tree owner, a user may enter or upload details about a tree 130A, or a plurality of trees 130, and their corresponding properties 135 (e.g., tree 130A may have properties 135A, tree 130B may properties 135B, etc., and different ones of the trees may have different properties) via an interface of the application 105 or website accessed by a browser 119.

In some embodiments, the registration service may facilitate establishment of a digital wallet for the user (e.g., corresponding to the platform 140) upon creating the user account or enable the user to specify an existing digital wallet of the user (e.g., in the case of a platform 140 which is public and on which the user has already established a wallet). In some embodiments, establishment of a digital wallet may comprises the generation of a private encryption key of a key pair, such as based on a passphrase, randomly, or based on some other value. A public encryption key of the key pair may be generated based on the private encryption key, and one or more addresses (e.g., of a digit wallet) may be generated based on the public encryption key. The digital wallet may be used to make a transaction such as buying or selling a tree token, may store funds in fiat currency or cryptographic currency, or may store information regarding one or more financial accounts using which a user can purchase a tree token or receive funds from selling a tree token. In some cases, the described information about trees may be stored with a UTXO (Unspent Transaction Output) model or some embodiments may use an account/balance model. In some embodiments, a mobile device 101 may store information about a user's wallet 110, which may be utilized by a native application 105, or a user may maintain information corresponding to their wallet by other means and utilize their wallet via a website or other interface.

In some embodiments, the registration service may also provide various tiers or types of accounts (or subscriptions) to which application users may register (or subscribe). For example, for a tree owner, a first-tier of subscription may be associated with privileges to functionality that permit a tree owner account user to list their trees, but may not allow them to participate in the adopt-a-tree program, whereas a second-tier of subscription may be associated with privileges to functionality that permit a tree owner account user to both list their trees and participate in the adopt-a-tree program. Similarly, for other users, a first-tier subscription may enable an account user to view the tree listings and to view tree tokens associated with the trees, but may not allow them to trade (e.g., buy or sell) the tree tokens, whereas a second-tier subscription may confer privileges to do both to an adoption account user.

In some embodiments, the application server 120 may provide a listing service via a native application 105 or website accessible via a browser 119 of a client device 117 by which a tree owner (e.g., a user having registered a tree owner account) may perform various operations on the platform, such as creating a unique listing for each of their trees, adding data that is descriptive of a tree for each of the trees, indicating whether the tree owner wants to participate in the adopt-a-tree program, receiving a generated tree token that corresponds to a tree listed by the tree owner, setting a price of the tree token, or listing the tree token for trade. The tree owner may add data or information (e.g., tree properties 135) regarding respective trees 130 manually (e.g., by inputting the data associated with a tree in a graphical user interface (GUI) associated with the listing service) or by importing the data from a file or another service (e.g., cloud storage service or another server) that hosts records of trees 130 and their respective properties 135 (e.g., such as one or more records which may correspond to surveys of trees of the tree owner). In some embodiments, listing service privileges for a tree may be dependent on a requirement that the tree owner certify ownership of the tree and their legal ability to participate in the adopt-a-tree program.

In some embodiments, the listing service may also provide an interface by which a tree owner may request certification of one or more trees. In some examples, a tree certification request may be processed by a certification service (e.g., offered by a third-party) for certifying a tree 130A and its corresponding properties 135A. For example, a certification service may generate a record (e.g., point in time) of a tree 130A that includes properties 135A corresponding to the tree, or certify the accuracy of a record of a tree 130A and its properties 135A. In some cases, a record of a tree 130A and its properties 135 may be cryptographically signed by the author, such as an arborist or tree appraiser or surveyor, e.g., with a private cryptographic key of a PKI key pair, and smart contracts may verify such signatures when accessing the supplied data with a corresponding public key.

The trees may be classified into various types and the listing service may require different data for different types of trees. For example, some different types of tees may have at least some different properties corresponding to the respective type of tree. For example, one such classification may classify a tree into one of three types—street trees, significant trees, and ecologically beneficial trees. Embodiments may have more or fewer classifications, or other classifications, or multiple types of classifications (e.g., classification by street, significant, or ecological and one or more other factors, such as size or age). In some embodiments, the street trees may be typically owned by an entity, such as a municipality. They may be maintained by the municipality and sometimes with the assistance of another entity, such as a non-profit organization. Such entities may maintain an inventory of the trees, including information about each tree and the location of the tree. They may also have measured and certified their tree inventory so they can quantify properties of the trees that are indicative of the ecological benefits of the trees (e.g., like a score for each tree). In some embodiments, the application server 120 or platform 140 may also provide services (e.g., that are either proprietary or requested from a third party) to certify a tree or estimate the value of a tree. In some embodiments, to list a street tree, the listing service may require the tree owner to provide information such as a title, genus, species, one or more pictures, location information such as latitude and longitude, ownership certification, creation or modification date, and information regarding third-party data verification of the tree.

In some embodiments, a significant tree is a tree that satisfies a specific criterion. Some significant trees may also be known as “Big Trees.” Any tree nominated as a Big Tree or significant tree may have to satisfy specific measurement requirements and may have to be validated by a separate entity, e.g., independent inspectors. The inspecting entity may visit the nominated tree and validate the measurements of the tree. Further, each of the Big Trees may be assigned a score using a formula that is based on the measurements. In some embodiments, Big Trees having a score above a first threshold in a particular region (e.g., state) may be granted a specific title, e.g., “State Champion Big Trees.” In some embodiments, Big Trees having a score above a second threshold in a particular region (e.g., country) may be granted a specific title, e.g., “National Champion Big Trees.” In some embodiments, information regarding Big Trees made available to the public by the tree owners. In some embodiments, significant trees could also include trees with a historical significance, e.g., “Witness Tree”—one that was alive during a period of time, such as the Civil War. In some embodiments, significant trees could also include trees planted by a famous person or a tree planted in memory of a person or event. There could be many such examples of significant trees and the significance would be shared by the tree owner. Further, tree owners may establish a value of their significant trees using their own value system and method, or use a service provided in association with the platform. In some embodiments, a tree may be judged as significant or not by user who buys a tree token associated with the tree listed as a significant tree. In some embodiments, the users may indicate that a particular tree is not significant in one or more ways, e.g., by explicitly indicating so in the platform, by not buying a tree token associated with the significant tree, or by offering an amount lesser than the listed price of the tree token. In some embodiments, to list a significant tree, the listing service may require the tree owner to provide information such as a title, genus, species, one or more pictures, location information such as latitude and longitude, significance information, ownership certification, creation or modification date, and information regarding third-party data verification of the tree.

In some embodiments, an ecologically beneficial tree is a tree that may have been measured and observed in such a way that the data known about the tree can be used to calculate the ecological benefits. Such benefits may include amount of carbon sequestered above and below ground, the amount of air the tree purifies over a length of time, the amount that the tree contributes to heating or cooling a nearby structure, etc. In some embodiments, tree owners, such as a Forestry Department, may work with other companies and non-profit organizations to continually develop and improve a model (or formula) that is used to estimate values (e.g., based on properties of a tree) that are indicative of the ecological benefits. Many tree owners, such as urban forestry groups working with municipalities, may have assessed their entire tree canopy based on the model (or equation) and may know the data needed to use, the formula, and the results from their study of their trees. In some embodiments, such estimation of the values may be verified or performed by arborists certified for this type of analysis.

In some embodiments, the ecologically beneficial tree may also be classified into one or more of the other types—street trees or significant trees. In some embodiments, to list an economically beneficial tree, the listing service may require the tree owner to provide information such as a title, genus, species, one or more pictures, location information such as latitude and longitude, significance information, ownership certification, creation or modification date, and information regarding third-party data verification of the tree. Further, the listing service may also require the tree owner to provide additional data, such as a diameter, sun exposure, health, records of measurement dates, and third-party measurement certification.

In some embodiments, tree owners may also list seedlings, which may be another classification of the trees. In some embodiments, the seedling may not have any (or fewer) environmental benefits at young stage of growth (e.g., at a given point in time, but cumulatively some benefits may exceed those of older trees) and therefore may not qualify for adopt-a-tree program (e.g., no tree token may be generated). However, the platform may create a different type of digital token specific to the seedling (e.g., “seedling token”), which is different from the tree tokens generated for other trees. The seedling token may be priced differently from the tree tokens (e.g., lesser than the price of the tree token). The seedling token may be converted to a tree token at a later time (e.g., when the tree is at a particular growth stage that provides ecological benefits), e.g. for a discount.

In some embodiments, tree owners may also list a section (e.g., like a collection) of seedlings, which may be another classification of the trees. A section, like a geographic area with defined geographic boundaries (e.g., in accordance with a land or tree survey), may correspond to an area within which tree seedlings were planted. The platform may create a different type of digital token specific to the section of seedlings (e.g., “section token”), which is different from the tree tokens generated for trees. The section token may be priced differently from the tree tokens, such as based on size of the area, density of the planting and type of seedlings planted or number of seedings planted, among other factors. The section token may be converted into a plurality of tree tokens at a later time (e.g., when the trees reach a particular growth stage). A section, in some embodiments, could also correspond to older growth, such as an area of forest, which may be measured by metrics such as types of trees included in the section, average age, and the like, which may also correspond to a section token or a different type of section token (e.g., old growth or seedling section). In each case, a section token may, at a later point, be converted into in a plurality of tree tokens corresponding to respective trees within the section. In some embodiments, a section token may be processed and reissued or updated (e.g., by appending one or more records referencing the section token) with indications of one or more trees and their respective tree tokens which are excluded from the section (e.g., because they were spun off into tree tokens while other trees remained within the section).

In some embodiments, other types of ecologically beneficial area may be listed as sections, which may correspond to a different type of section token corresponding to the ecological type of the area. Examples may include swamp or wetlands, wildflower areas, and the like, which may be existing or recently cultivated (e.g., revitalization efforts). Ecological benefits of such sections may be quantified based on their properties in accordance with respective models (or functions) based on finding of experts with respect to the different types of sections. Such sections may be represented uniquely by NFTs that correspond to an area (e.g., like a habitat) rather than a specific tree or collection of trees (which is not to suggest that one or more tree tokens may not correspond to trees identified within such example sections, and may be referenced as excluded from the section and listed separately).

The listing service may allow the tree owners to update the listings (e.g., add, delete, or modify) a tree listing or data of a tree within a tree listing. For example, for ecologically beneficial trees, the estimates of the values can be adjusted when new measurement or observational data is available. Further, the above-mentioned tree types and the data of the trees required for listing are just examples. It should be noted that the listing service may allow the trees to be classified into more or less types than mentioned above, or may require more or less data than mentioned above to list the trees. The listing service may provide a GUI for searching or viewing information regarding a tree. The tree information displayed may include one or more parameters associated with a tree, such as tree owner information, a title, genus, species, one or more pictures, location information, estimated value of the tree, carbon sequestered from the tree, etc. A user may search for tree information using one or more search parameters (e.g., search by tree owner, genus, specie, location information, estimated value, etc.). In some embodiments, information regarding a tree (or a section) may be stored within the data store, such as directed acyclic graph 150, such as in a record. The record may be structured in accordance with a given schema, such as a schema of information for input into a smart contract 145 by which a NFT, like a tree token, may be generated. In other examples, such information may be structured in accordance with the given schema, such as by the application server 120, for input to the smart contract 145 by which a NFT, like a tree token, may be generated. In either instance, a record of the generation of the NFT may be stored within the data store, and may include information like a token identifier and an account to which the token was transferred (e.g., to a tree owner, such as initially, or other account of a user such as when an account user trades for the token (e.g., adoption, purchase, or otherwise).

A tokenization service, such as a NFT tokenization service implemented by a smart contract 145 executed by participant computing nodes 141 of the platform, generates a tree token for a tree upon submitting the tree for tokenization. In some embodiments, a tree may be submitted for tokenization when a listing for the tree is created and if the tree owner has indicated in the tree listing their acceptance to participate in the adopt-a-tree program. In some embodiments, a tree (e.g., that is listed on the listing service and verified as available for adoption) may be submitted for tokenization upon indication of a request for adoption of the tree by a user of the adopt-a-tree program (and the tree may be indicated within the listing of trees as adopted, e.g., as having a corresponding tree token within circulation on the platform).

As mentioned above, the tree token can be a cryptographic token, such as an NFT. The tokenization service, such as a smart contract 145 which takes as input information about a tree 130A, including properties 135A of the tree, and generates different tree tokens for different trees, that is, the tree tokens are unique, and that uniqueness may be conveyed at least by unique token identifiers (e.g., no two tree tokens in the platform may have the same token identifier). In some examples, that uniqueness may be conveyed by additional characteristics unique to a token to users. One such characteristic of the tree token can be a visual appearance of the tree token, which may be a combination of attributes such as color, shape, theme, content etc. The tokenization service may allow a tree owner to set one or more attributes of the tree token, such as a price of a tree token, whether to list in the online marketplace of the platform for trading, date and time to be launched in online marketplace, etc. As noted above, a tree token may be associated with a smart contract 145. In addition to generating a tree token, the smart contract 145 may define or control the distribution of funds from a sale and transfer of the tree token with various entities such as the tree owner, other users associated with the platform that may purchase or trade tree tokens, and an application server which may provide tracking or listing information about tree tokens (e.g., to user's devices based on records within the data store or other information obtained from other sources). In some embodiments, one or more entities may receive a portion of a sale as defined by the smart contract 145. In some embodiments, one or more entities (e.g., such as the tree owner or application server 120) may receive a portion of every sale of a tree token (e.g., a first sale from the tree owner to a buyer, and one or more subsequent sales of the tree token from one user to another user). In some embodiments, some entities may not receive any portion of the funds from subsequent sales (e.g., a user account from sale or trade transfers involving the tree token that occur subsequent to the user account transferring the tree token to another user account). In some embodiments, the tree owners may get the largest percentage of the sale price on the initial token sale and after that a small recurring revenue stream from subsequent sales.

The tokenization service, such as a smart contract 145 by which tree tokens are generated, may associate each generated tree token with one or more attributes, such as a unique token identifier (e.g., as an identifier or based on an identifier of the tree for which the tree token is created), association of the tree token identifier with an identifier (e.g., like a unique address) of the smart contract, name (e.g., which may be the identifier of the tree, and may be unique), genus and species of the tree, an image of the tree, a link to the tree listing in the platform, a smart contract, etc. As described above, the smart contract may define how initial sale proceeds are distributed among various entities, how subsequent sale proceeds are distributed among the various entities, how token pool funds are distributed, etc. In some embodiments, the smart contract may also add a transaction fee for every sale of the tree token and define how the amount collected as the transaction fee is to be distributed to various entities. The tokenization service, such as smart contract 145, may deliver a generated tree token to a digital wallet of a tree owner. The smart contract 145 may also facilitate the transfer of a tree token from the digital wallet of the tree owner to another user, and between other users (e.g., subject to criteria upon which transfer of the tree token is governed, which may be enforced by the smart contract). Further, the tokenization service may also provide a listing of tree tokens that are associated with the smart contract 145 (e.g., which the smart contract generated), and may list a newly generated tree token on the online marketplace for sale at a launch date and time (e.g., as specified as inputs for generation of the tree token). Any tree token in the platform may reference a tree listing.

In some embodiments, the application server 120 may provide an online marketplace based on information about records involving tree tokens on the platform. In some embodiments, the online marketplace may provide (e.g., via the API 125 to one or more mobile devices 101 or client devices 117 requesting information about tree tokens) a listing of tree tokens available for trading and may facilitate (e.g., via a smart contract 145) the exchange of tree tokens. For example, tree owners or users may provide indications of availability of one or more tree tokens within their digit wallet. In some examples, a user of a mobile device 101 may utilize a native application 105 to provide such indications of availably in association with a token reference 115 (e.g., a unique token identifier) corresponding to a tree token held within their wallet 110. Other users, such as other users of other mobile devices utilizing the native application 105 or users of client devices 117 which may access a website associated with the application server 120 via a browser 119, may access the online marketplace to view listings of tree tokens available to add to their digital wallet. For example, a buyer may select one or more tree tokens from the online marketplace to purchase and request the tree tokens be delivered to their digital wallet. A set of input information corresponding to the request (e.g., fund availability, token availability, etc.) may be verified by the application server 120 (e.g., optionally, prior to calling a smart contract 145 to execute the transfer) and smart contract 145 by which the transfer of the one or more tokens is processed (e.g., the smart contract 145 may comprise rules or other criteria, such as fund and token availably, to process the transfer). In another example, a user may sell a tree token (e.g., bought from a tree owner) to another user in the online marketplace. In yet another example, a tree owner may buy back the tree token from a user currently holding the tree token. A user holding a tree token within their digital wallet may update the marketplace listing (e.g., price, or other criteria to be met for a transfer of the tree token to another user) at any time prior to a transfer. A user holding one or more tree tokens may remove or relist their tree tokens on the marketplace for sale at any time. The online marketplace may provide a GUI (e.g., via the native application 105 or interfaces of a web site associated with the application server 120) for the viewing, searching and trading of the tree tokens. A user may search for tree tokens using one or more search parameters (e.g., search by seller, tree owner, genus, specie, location information, token price, etc.).

The mobile device 101 may be a mobile computing client device (e.g., a portable device, like a laptop, mobile phone, tablet, etc.) to which a user has access to and may use to register with the tree tracking system (e.g., with one or more of the platform 140 and application server 120). Once registered, the user may use the mobile device 101 to perform one or more different functions such as providing information about one or more trees 130 and their properties 135, request certification about one or more trees (e.g., owned by the user), request generation of a tree token corresponding to a tree owned by the user, view listings of available trees or tree tokens, purchase tree tokens, among other activities described herein. For example, the mobile device 101 may include an example native application 105 by which the user may interface with operability of the tree tracking system. In some embodiments, the native application 105 may interface with a wallet 110, like a digital wallet, of the user on the mobile device 101, or provide digital wallet functionality, and the wallet may provide indications of tree tokens, such as by token references 115 to respective tree tokens, which are held within the user's digit wallet. The native application 105 and wallet 110 may exchange information with the application 120 or the platform 140 over a network 121, such as the internet. The native application 105 may request or submit information to the application server 120 via the API 125, such as to receive information corresponding to one or more interfaces and submit information via one or more such interface. In some embodiments, the native application 105 may be configured to interact with the platform 140, such as by submission of a transaction (e.g., request to process the transaction) onto the platform 140 via one or more computing nodes 141, which may include the calling of a smart contract 145 to process the submitted transaction. In some embodiments, the application server 120 may receive information corresponding to a requested transaction and facilitate the submission of the transaction onto the platform 140.

An example client device 117 may be a computing device like a laptop, desktop, or workstation operated with network 121 access in a home, office, or field environment. The client device 117 may provide user access to functionality of the tree tracking system via a browser 119, like a web browser application, which may access a website that provides functionality similar to that of the native application 105 (e.g., as described above). For example, the website may be a website hosted by the application server 120, and which may be serviced by the API 125, to provide and receive information via one or more user interfaces of the website.

The application server 120 may be a computing device or collection of computing device associated with a trusted party that provides tree tracking services on the platform 140. As shown, the application server 120 may include API 125 for processing information associated with tree tracking services. The application server 120 may configure and publish a smart contract 145, which may be executed by computing nodes 141 of the platform 140 to provide backend on-blockchain functionality associated with the tree tracking service. In some embodiments, the smart contract 145 may include some or all of the functionality of the API 125 and specify a data structure to which requests to generate a tree token must conform and other criteria. In some embodiments the smart contract 145 may be configured to make calls to the API 125 of the application server 120 to retrieve information, like properties of a tree in accordance with the data structure or verification of properties of a tree for the generation of tree tokens. In some examples, the application server 120 may publish (e.g., to the data store in one or more records) identifiers, such as public keys, associated with entities or persons verified to certify properties of a tree (e.g., as a criteria for generation of a tree token), and the smart contract 145 may be configured to verify a signature of certified data relative to input data of the data structure as criteria for generation of a tree token.

In accordance with aspects of the example environment 100 of a tree tracking service as outlined above, a user may obtain tree tokens within their digital wallet in a variety of ways. For example, after registering, the user may access a listing service (e.g., via a web browser by using an URL associated with an applications server or platform or via a mobile application associated with the platform) to view trees or tree tokens, select a tree (or tree token corresponding to a tree) from the listing service, access a link from the tree listing to buy the tree token, which may render a GUI of the online marketplace in the web browser or the mobile application where the user can proceed with buying the tree token using their digital wallet. In another example, the user may access the online marketplace (e.g., via a web browser, such as browser 119 by using an URL associated with the platform or via the mobile application, such as native application 105), select one of the tree tokens listed in the online marketplace, and proceed with buying the tree token using the digital wallet. The user may optionally access the link associated with the tree token to view the information about the tree (e.g., based on one or more records including properties of the tree within the decentralized data store, examples of which include directed acyclic graph 150, or information obtained from the application server 120 or other repository which may be verified as unaltered based on one or more records within the decentralized data store) in the tree listing prior to buying the tree token. In yet another example, the user may access the tree listing using information from an actual physical tree. For instance, the user may engage a camera of a mobile device to take a picture of the tree and upload the picture to the platform (e.g., via a web browser or mobile application), which may execute logic to automatically identify the tree (e.g., using image recognition or other methods) and to cause a GUI having the listing of the particular tree rendered in the mobile device (e.g., in a web browser or the mobile application). In another instance, the user may engage the camera of the mobile device to scan a visual identifier associated with a tree, such as a quick response (QR) code or bar code, which may cause the mobile device to request a listing of the particular tree at a uniform resource locator (URL) that resolves to an IP address of the platform, which may respond to the request with a GUI having a listing of the particular tree rendered in the mobile device (e.g., via a web browser or mobile application). In yet another instance, in response to receiving a request for a listing of a tree from the mobile device, the platform may obtain location information (e.g., latitude/longitude, or other such geolocation information) from the mobile device, identify the tree near the user based on the location information and respond to the request with a GUI having a listing of the particular tree rendered in the mobile device (e.g., via a web browser or mobile application). The mobile device can include any portable computing device, such as a laptop, a tablet PC, a smartphone, a wearable device, etc.

After selecting a tree token, the user may proceed with buying the tree token using their digital wallet. The online marketplace may optionally display a message indicating that the payment made by the user is a donation to the tree owner. Users may buy or sell tree tokens using fiat currency, or digital currency such as cryptocurrency. After the purchase is completed successfully, the online marketplace may call a smart contact to execute the transfer the tree token to the digital wallet of the user based on a verification of information associated with the request transaction (e.g., donation meets criteria, validation of token ownership by the tree owner, etc.). For example, an indication of the generation of a tree token 171 may be stored by a transaction Tx 1 to the data store (e.g., the instantiation of a unique tree token is record in block 11 of the graph). A transaction Tx 2 in another block, such as block 12, may correspond to an indication of the transfer of the generated token to a user account A 21. Another transaction, such as Tx 3, may correspond to a transaction by which ownership of the token 171 is transferred to user account B 31. The user of user account A 21 may, for example, list the token 171 as available for purchase, and the user of user account B 31 may purchase the token, the purchase being recorded as a transfer of the token 171 to user account B 31 by Tx 3 within block 12. The smart contract(s) associated with the tree token may perform one or more verifications (e.g., of records within the data store to verify ownership and availability of funds) and effectuate the transaction Tx 3 recording the transfer as well as distribute the funds from the sale accordingly (e.g., by one or more other transactions or as indicated within transaction information associated with Tx 3).

A user with access to their digital wallet that holds a tree token may choose to list the tree token for sale or for trade (e.g., to another user) via the online marketplace. The selling user may set criteria such as sale price or trades for transferring the tree token to another user that differ from criteria the user previously met to obtain the tree token from a tree owner or another user. In another instance, a user may choose to buy a tree token from another user, who may not be a tree owner. Criteria by which a purchase or trade are deemed to be accepted (e.g., meeting a threshold price) may be enforced, such as by rules of a smart contract (or by the applications server) that verify a purchase meets the listing criteria, such as by ensuring the availability of funds corresponding to the purchase that cover any transactional fees and the price of the token, and may also verify that no other transaction indicative of a transfer of the token is pending (e.g., such as by another pending or processed transaction indicating transfer of the token from the token hold indicated in the listing).

In some embodiments, the application server or smart contract may implement a privacy service that may conceal certain information from some users or types of user accounts. For example, the application server or smart contract may verify, e.g., by cryptographic signature, but may not publish certain raw tree owner information or geolocation information of a tree to the data store. For example, certain information may be represented by one or more cryptographic hash values (e.g., outputs of a one-way cryptographic hash function, like a SHA256 hashing function) by which authenticity of the data may be validated (e.g., at a later date, by recomputing the hash and verifying a match of the hash values) without exposing raw data in plaintext. Some embodiments may encrypt certain data, for example, the application server 120 may encrypt certain values and retain a key (e.g., securely) by which the data was encrypted. The application server 120, having a role as an authority within the context of the tree tracking system, may provide results of data verifications subject to processing of encrypted values.

In some embodiments, the application server or smart contact may implement a carbon credit service to compute carbon credits based on carbon sequestered from a single tree. In some embodiments, the carbon sequestration can be computed based on available tree data corresponding to the physical tree to which a tree token corresponds. The carbon credit service may provide for the processing of a tree token to obtain carbon credits for trade in the online marketplace. The amount of carbon credits generated, which may be allocated to the digital wallet of the holder of the tree token, may be based on the properties of the tree that are indicative of an amount of carbon sequestered and an amount of carbon sequestered since a last generation of carbon credits corresponding to the tree token. In some embodiments, a tree record or other information about properties of a physical tree may be updated, such as by a transaction Tx 4 in block 13 that indicates a tree token or tree record to which the update corresponds. For example, update information 173 include by the transaction may include updated properties corresponding to a physical tree, which may be considered for the determination of an amount of carbon sequestered by the physical tree to which the tree token corresponds. A process to compute an amount of carbon sequestered may obtain update records (e.g., up to a current block, such as block 15, which may be verified, e.g., by signature verification based on a public key corresponding to a tree certification service to ascertain their authenticity. A process to compute a benefit corresponding to a tree token may effectuate a transaction, such as Tx 5 in block 14, indicative of the benefit, like an amount of carbon credits allocated to a digit wallet of a tree token holder based on processing of the tree token, such as based on properties of the physical tree to which the tree token corresponds, and which may consider updated properties 173 based on timestamps (e.g., of Tx 4) associated with the update or certification date that correspond to a tree token.

In some embodiments, computation of carbon credit and transaction data associated with the trading of carbon credits may be stored in the blockchain-based data repository. In some cases, fungible carbon-credit tokens (e.g., ERC-20 standard-compliant tokens, said standard being incorporated by reference) may be minted (e.g., periodically) and added to wallet accounts of owners of tree tokens based on a tree model, which may model a proportional allocation of credits to a holder of one or more tree tokens based on the proportion of carbon sequestered by the physical trees (e.g., based on an output of the model that takes properties of a trees or trees as input). The tree model may be encoded in a smart contract and may take as inputs properties of the trees corresponding to tree tokens held by respective digital wallets. In some cases, the tree model may, for example, allocate more fungible carbon-credit tokens for a tree with a larger diameter, warmer climate, more rain, more sunlight, during spring, or of a particular type than for a tree with less optimal properties for sequestering carbon.

In some embodiments, an address of a smart contract may be called with an API call (i.e., a request) including request parameters such as the address and one or more values for arguments defined in the schema of the smart contract. The smart contract may perform one or more verifications, such as signature verifications, based on PKI information, where a public key may be associated with different user accounts or certification entities or an application server or user by which information for processing (e.g., as indicated by a request or in a record) may be vetted. The schema may be enforced by the smart contract, such as by rejecting requests with non-conformant inputs, or lacking one or more required inputs, upon failure to verify one or more required cryptographic signatures, or failure to match a cryptographic hash between input data and implicated data (e.g., indicating a discrepancy). In some embodiments, the smart contract may respond to the API call by executing a process to perform a function within the tree tracking system, and the function may include storing a transaction record on the blockchain that records the request or results to the blockchain. This, in some cases, may include calculating a cryptographic hash value (or values) based on the request or the results and a cryptographic hash value of one or more other transaction records in the blockchain by which the results were determined. In some cases, a new entry (e.g., a new transaction record, which may correspond to the establishment of a tree record, generation of a tree token, transfer of a tree token to a user account, or other function described herein) created by the smart contract may include this cryptographic hash value and pointers to those other nodes. In some cases, such as for the other transactions records in the blockchain by which the results were determined, the transaction record may include in association with the cryptographic hash value or pointer an indication of which arguments or other criteria were satisfied according to that transaction record to arrive at the results.

In some embodiments, a directed acyclic graph comprises cryptographic hash pointers to provide a tamper-evident, immutable, decentralized data store to which the smart contracts are stored and to which transaction records accessed by the smart contracts are stored, which in some cases may include results determined by the smart contracts as well as requests and their arguments to the smart contracts. In some embodiments, storing a transaction or smart contract to the directed acyclic graph may include storing a record all of the information of that transaction or smart contract (e.g., the program code of the logic of the smart contract that is executed by the computing nodes (e.g., in a virtual-machine) of the decentralized computing platform corresponding to a target of byte code into which smart contracts are interpreted) in content of nodes (e.g., a node in a tree of nodes, like a Merkle tree, and a given tree may be stored in a block) of the directed acyclic graph of cryptographic hash pointers. Cryptographic hash pointers pointing to those nodes include cryptographic hash values (as part of node content of the node that is pointing) that are based on node content (of the node to which the pointer points) that includes the record of stored information (e.g., transaction information or smart contract information), thereby defining a chain of cryptographic hash pointers that becomes increasingly computationally expensive to modify (while remaining internally consistent) in the event of attempted tampering as the chain increases in length or tree increases in size. In some embodiments, a plurality of different directed acyclic graphs of cryptographic hash pointers may store different subsets of the information, may store replicated instances of the information, or in some cases a single directed acyclic graph of cryptographic hash pointers may store all of this information. In some cases, the directed acyclic graph is a sub-graph of a larger graph with a cycle, and in some cases the directed acyclic graph includes unconnected subgraphs. For example, different types of transactions or smart contracts may be stored in different sub-graphs of the directed acyclic graph.

In some embodiments, recording of information like a transaction (which may correspond to storage of tree record information or a generated tree token and associated criteria or information by which the resulting determinations (e.g., to store or generate) were made, transfer of tree tokens or transfer of funds or other criteria or information may which the resulting determinations (e.g., transfer token ownership or funds) were made) to the directed acyclic graph of cryptographic hash pointers is achieved by storing a digest of the information in node content of the directed acyclic graph of cryptographic hash pointers. In some cases, the digest may include some plaintext information, such as tree properties, and cryptographic hashes of other information, or all plaintext or all cryptographic hashes. In some examples, one or more of the cryptographic hashes in a cryptographic hash portion of the digest may reference other content, like records, transactions, or tokens within other nodes of the data store, e.g., an update may include a hash digest referencing prior updates and a tree token or original tree record. The cryptographic hashes included in record or token information may be operable to identify (e.g., other transactions in other nodes by cryptographic hash pointer, e.g., a transaction storing updated properties of a tree may reference a tree record or tree token to which the updated properties correspond) or verify information (e.g., on-chain or off-chain information by cryptographic hash) associated with the transactions.

In some embodiments, a transaction may include one or more public keys, user account identifiers, or representations (e.g., a hash) of such information or other information stored outside of the data store. In some embodiments, a public key may be considered a representation of a credential (e.g., a private key) because it is representative of some other knowledge (the private key) held in confidence by a user or entity without being exposed. Data, and a signature of the data as signed by the private key, may be exposed for signature verification (e.g., by a signature verification function that takes as input the signature, the data that was signed, and the public key and outputs a verification that the signature was generated based on the private key of a key-pair of the private key and the public key) as proof that the user or entity has access to the private key. In some embodiments, a public key may be a user account identifier or an identifier of an entity, as that public key corresponds to a private key retained by a given user or entity.

Information stored outside of the data store (and within) may be verified as having been untampered with based on matching of cryptographic hashes. For example, a cryptographic hash of properties of a tree may be associated with a tree token. The properties of the tree may be stored within a record within or external to the data store. A tree (e.g., uniquely represented by the properties) may be verified as corresponding to the tree token recalculating a cryptographic hash value based on the asserted properties and verification of a match with the cryptographic hash associated with the tree token (e.g., which may have been computed in association with the generation of the tree token). Upon determining that the hash values match, the asserted properties, such as in correspondence to a unique identifier of the tree, may be determined to have not been subject to tampering (e.g., can be verified), or upon determining that the values do not match, it may be determined to have been tampered with (e.g., cannot be verified). Further, to verify that a cryptographic hash value in the data store has not been tampered with, some embodiments may recalculate cryptographic hash values along a chain of cryptographic hash pointers to confirm that the recalculated values match those in the directed acyclic graph (e.g., can be verified), thereby indicating the absence of tampering (or upon detecting a mismatch, indicating the presence of tampering and cannot be verified).

For example, content of nodes of a directed acyclic graph, e.g., of cryptographic hash pointers, may be verified as having not been subject to tampering by determining whether that content is consistent with one or more chains, or other associative data structures (e.g., trees), of cryptographic hash pointers of the directed acyclic graph. In some embodiments, nodes of the directed acyclic graph of cryptographic hash pointers may include as node content a node identifier (e.g., an address in the graph) that distinguishes a node from other nodes of the graph, identifiers or one or more other nodes of the graph to which a cryptographic hash pointer of that node points, and an associated cryptographic hash values based on node content of those other identified nodes to which the cryptographic hash pointers point (in some cases, the pointing is from one and only one node to one and only one node for adjacent nodes). As additional nodes are appended to the directed acyclic graph, a chain of cryptographic hash pointers may be formed such that each subsequent node includes as node content one or more cryptographic hash values based upon some, and in some cases all of the previously published information published to the directed acyclic graph of cryptographic hash pointers. In some embodiments, following these pointers may be requested by a function which verifies that stored transaction records have not been tampered with or subject to other transactions such as to verify that a digit wallet holds a given token, verify record of token transfer, verify a correspondence of tree records to properties of physical trees or to a corresponding tree token generated based on the tree record, uniqueness of a token, or other information stored within the data store. The directed acyclic graph of cryptographic hash pointers need not be referred to as a graph, or as having nodes or edges, in program code to constitute a graph, provided that a data structure affords the same or similar functionality, even if that data structure bears different labels. Similar qualifications apply to transaction records and the information they store or represent as described herein. For instance, graphs may be encoded in objects in object-oriented programming environment, key-value pairs, entries in a relational database, documents encoded in a hierarchical data serialization format, or combinations thereof, without being labeled as graphs.

FIG. 2 is a flowchart of an example of a process 200 executed by an application server and/or a computing node with a smart contract in accordance with some embodiments of the present techniques. Process 200 may be implemented to determine whether to effectuate a transaction to store (e.g., publish for storage or a corresponding result indicative of the storage of) a tree record to a tamper-evident, immutable, decentralized data store. In some cases, the process 200 is executed by one or more computing nodes of a decentralized data store and/or an application server, though embodiments are not limited to that implementation, which is not to suggest that any other description herein is limiting. For example, in some cases an application server may operate as, or include, a computing node, and in some cases, some steps may be performed by an application server and some steps by a computing node executing a smart contract. In some embodiments, the functionality described with respect to FIG. 2 and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 200 includes receiving, with one or more processors, a request 202 to store a tree record, which may establish a record of a new physical tree a tree owner is requesting to be added to the platform. In some embodiments, an address of a smart contract may be called with an API call including the information described below. In some embodiments, the smart contract may respond to the API call by executing a transaction on the blockchain that records information to the blockchain. In some embodiments, the smart contract may perform one or more API requests to other entities to retrieve some of the information described below for processing. For example, a request may specify storage locations of some information and the smart contract may be configured to retrieve that data. All or a subset of the information may also be provided in a request. In some embodiments, the request 202 may also correspond to a request to tokenize a physical tree, such as in association with storage of the record of the physical tree.

In some embodiments, an address of a smart contract may be called with an API call (i.e., a request) including request parameters such as the address and one or more values for arguments defined in the schema of the smart contract. The smart contract may perform one or more verifications, such as signature verifications, based on PKI information, where a public key may be associated with different user accounts or certification entities or an application server or user by which information for processing (e.g., as indicated by a request or in a record) may be vetted. The schema may be enforced by the smart contract, such as by rejecting requests with non-conformant inputs, or lacking one or more required inputs, upon failure to verify one or more required cryptographic signatures, or failure to match a cryptographic hash between input data and implicated data (e.g., indicating a discrepancy). In some embodiments, the smart contract may respond to the API call by executing a process to perform a function within the tree tracking system, and the function may include storing a transaction record on the blockchain that records the request or results to the blockchain. This, in some cases, may include calculating a cryptographic hash value (or values) based on the request or the results and a cryptographic hash value of one or more other transaction records in the blockchain by which the results were determined. In some cases, a new entry (e.g., a new transaction record, which may correspond to the establishment of a tree record, generation of a tree token, transfer of a tree token to a user account, or other function described herein) created by the smart contract may include this cryptographic hash value and pointers to those other nodes. In some cases, such as for the other transactions records in the blockchain by which the results were determined, the transaction record may include in association with the cryptographic hash value or pointer an indication of which arguments or other criteria were satisfied according to that transaction record to arrive at the results.

In some embodiments, the process 200 includes determining a transaction cost 204 corresponding to the processing and storing of record data within the data store. In some embodiments, determining transaction cost 204 comprises obtaining tree data 205 or representation thereof. For example, the process may obtain, with one or more processors, information associated with the tree, such as a plurality of properties of the tree and ownership information corresponding to the tree.

The request 202 may specify a location (e.g., a URL or other storage location of a record of tree properties, identifier of the tree or ownership data, which may correspond to a file (or different files) stored by an applications server or provided by a user) or otherwise include tree properties information, such as file corresponding to the tree. In embodiments, such as where the obtained tree data is stored to the data store, determining transaction cost 204 may comprise a computing of an amount of cost required to perform a function for storing the obtained tree data (e.g., to establish a tree record), and the amount of cost required may correspond to a size of the data. Thus, the transaction cost, or amount of cost required, may be a sum of the cost required to perform one or more functions for storing the tree data to the data store. In some example, multiple transaction or records may be stored, such as multiple trees, or a unique tree token may be generated in association with the storing a tree record. Thus, for example, some embodiments may determine, with one or more processors, a cost for effecting one or more transactions to generate a unique token having a correspondence to the tree, the unique token being tracked within a tamper-evident decentralized data store, wherein determining the cost comprises determining a first subcost for storing a record of the tree in a unified schema and a second subcost for generating the unique token corresponding to the tree.

In some embodiments, the process 200 includes translating 206 and obtained tree data into a unified schema for tree records, which may be processed to generate tree tokens. The translating 206 may comprise translating the obtained tree data from a format in which it is obtained to the unified schema for tree records. In some embodiments, tree ownership information (e.g., defining metes and bound of land, set of rights, or management thereof) may correspond to an indication of ownership of the physical tree. Tree properties may include information like that described herein that is descriptive of the physical tree for which a tree token is to be generated (or may later be generated based on). Obtained data may be parsed to identify keys in the schema of the obtained data and values corresponding to those keys. In turn, those identified keys and their corresponding values may be translated into key-value pairs in the unified schema. Further, those key-values pairs may structured hierarchically in the unified schema. The resulting key-value pairs in the unified schema may be processed into a data structure specified by the unified schema for storing properties of trees or ownership information, such as XML, or JSON code or a vector descriptive of the tree and its ownership. For example, the process may identify, with one or more processors, based on the obtained information associated with the tree, values of keys specified by the unified schema to which valid records of trees conform, and may identify values of keys corresponding to ownership information by which ownership may be verified.

In some embodiments, the process 200 includes verifying requirements 208 for executing the requested transaction. For example, requirement verification 208 may include determining whether transaction fees 207 are available for processing the transaction. This may include checking that a balance of a wallet associated with the entity requesting the transaction has available funds to cover the transaction costs determined at block 204. In some embodiments, the verifying requirements 208 includes verifying a signature associated with the request. For example, the process may include verifying, with one or more processors, at least some of the identified key-value pairings based on requirements for generating the unique token corresponding to the tree. For example, embodiments may verify a cryptographic signature of a tree certification authority attesting to the plurality of properties of the tree. Some embodiments may only tokenize a physical tree subject to attestation of the asserted properties thereof by an arborist or other approved authority (e.g., to prevent misuse of the system). Some embodiments may verify a cryptographic signature of an owner of the tree associated with the ownership information and attesting to the request to tokenize the physical tree. For example, a verified owner or manager of the physical tree may be permitted to tokenize the tree, but not some other individual (e.g., because a given tree may only correspond to a single unique token instance). Additionally, availability of funds equal or greater to the determined cost in a digital wallet associated with requestor (e.g., verified owner) may be verified. In some embodiments, a signature corresponding to a signature authority (e.g., like the application server) may be required along with a signature corresponding to an entity (e.g., the owner of the tree), where the signature authority verifies the identity of the entity, and may also verify ownership of the tree by the entity off-blockchain. In some embodiments, the verifying requirements 208 includes verification of the signature of the signature authority. In this way, transaction processing may be restricted to only requests deemed reputable.

In some embodiments, the process 200 includes determining 210 with one or more processors, whether to execute one or more transactions to effectuate the request based on the result of the requirement verification at step 208. If the requirements are not verified, the request may be rejected 216. The rejection may specify the requirements not met during verification. If the requirement are verified, the request may be effected as a transaction in blockchain 212. For example, one or more transactions effecting the request may be published to a tamper-evident, immutable, decentralized data store. For example, for establishment of a tree record, point in time or historic tree property information may be stored (e.g., published) to the data store or blockchain. Tree record information in the unified schema may be formatted into a data structure, like XML or JSON code, or a vector, and stored (e.g., published) to the data store or blockchain. The transaction fees 207 verified at step 208 can be utilized to provide the cost for effectuating the transactions 212, such as by deducting the amount of cost from the wallet for the respective functions. In some embodiments, a cost corresponds to generation of a tree token based on the record, which may be conveyed to an entity, such as a wallet associated with the application server. Embodiments of the process may effectuate, with one or more processors, a first transaction to store the record of the tree within the tamper-evident decentralized data store, and effectuate, with one or more processors, a second transaction indicative of generation of a unique token identifier of the unique token corresponding to the record of the tree and transfer of the unique token to the digital wallet associated with the owner.

In some embodiments, the process 200 include returning a result 214 for the processing of the transactions. In some cases, returning the result 214 comprises monitoring the blockchain to determine that the transactions have been published. In some cases, returning a result 214 comprises monitoring the blockchain to determine that the transactions have been published to a block of the blockchain and are considered authoritative. The returned authorization 214 may comprises one or more of a transaction ID, token ID or tree record ID, and other identifiers, such as of a smart contract or a wallet to which a generated token was transferred.

In some embodiments, on-chain information may be stored according to a data structure specified by a unified schema, and the unified schema may be implemented in a smart contract. Different smart contracts for different functions may have different unified schemas, but each different schema may be considered unified for a given type of transaction record (e.g., according to function within the tree tracking system). For example, a transaction record corresponding to the enumeration of a tree record within the tree tracking system may have a different unified schema than a transaction record corresponding to generation of a token or determining ecological benefits to issue to carbon credits to a tree token holder. A unified schema may be consistent across the different types of transaction records and unused data fields or values left null, blank, or omitted within node content having the data structure specified by the unified schema. Some embodiments may specify which keys have optional or required values. Information having a data structure specified by a unified schema may be stored as node content by one or more transactions and may include a machine-readable portion, such as a portion of key-value pairs in dictionaries encoded as a hierarchical data serialization format, like JavaScript™ object notation (JSON) or extensible markup language (XML). In some embodiments, an off-chain portion may be a human-readable format including unstructured natural language text or clear-text that describes in prose information in the transaction. For example, an off-chain portion may describe different properties of a tree or token generation criteria, and other factors that may be represented by values or ranges of values within the machine-readable portion. Or in some embodiments, this allocation may be reversed, intermingled, or otherwise differently arranged, which is not to suggest that any other feature herein is not also amenable to variation relative to the arrangements described. In some embodiments, the data structure includes both XML or JSON code or vectors, for example, a value of a key-value pair may be a vector comprising an ordering of tree properties or tree ownership information, and may include one or more signatures and corresponding public keys by which a PKI may serve to determine an association of the public key with an entity approved for certain activities. In some embodiments, records of trees, tree tokens, and other information in a unified schema may be stored into a data structure, which may be specified by the unified schema, that may be stored on the blockchain. In some cases, record of trees (e.g., trees and their properties) may conform to one unified schema while tree tokens may conform to a different unified schema. For example, a unified schema may be operable to codify trees and their properties, such as to track point in time information about one or more trees.

FIG. 3A is a flowchart of an example of a process 300A executed by an application server and/or a computing node with a smart contract in accordance with some embodiments of the present techniques. Process 300A may be implemented to determine whether to effectuate a transaction indicative of generation (e.g., publish for storage or a corresponding result indicative of the storage) of a tree token to a tamper-evident, immutable, decentralized data store. In some cases, the process 300A is executed by one or more computing nodes of a decentralized data store and/or an application server, though embodiments are not limited to that implementation, which is not to suggest that any other description herein is limiting. For example, in some cases an application server may operate as, or include, a computing node, and in some cases, some steps may be performed by an application server and some steps by a computing node executing a smart contract. In some embodiments, the functionality described with respect to FIG. 3A and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 300A includes receiving, with one or more processors, a request 302 to generate a tree token, which may establish an instance of a new, unique token (e.g., like an ERC-721 token) that corresponds to a physical tree. For example, a tree owner may request the generation of a tree token corresponding to a physical tree that is owned or managed by the tree owner. Generation of the tree token may establish an instance of a transferable representation of that specific physical tree on the platform. In some embodiments, an address of a smart contract may be called with an API call including the information described below. In some embodiments, the smart contract may respond to the API call by executing a transaction on the blockchain that records information to the blockchain. In some embodiments, the smart contract may perform one or more API requests to other entities to retrieve some of the information described below for processing. For example, a request may specify storage locations of some information and the smart contract may be configured to retrieve that data. All or a subset of the information may also be provided in a request.

In some embodiments, an address of a smart contract may be called with an API call (i.e., a request) including request parameters such as the address and one or more values for arguments defined in the schema of the smart contract. The smart contract may perform one or more verifications, such as signature verifications, based on PKI information, where a public key may be associated with different user accounts or certification entities or an application server or user by which information for processing (e.g., as indicated by a request or in a record) may be vetted. The schema may be enforced by the smart contract, such as by rejecting requests with non-conformant inputs, or lacking one or more required inputs, upon failure to verify one or more required cryptographic signatures, or failure to match a cryptographic hash between input data and implicated data (e.g., indicating a discrepancy). In some embodiments, the smart contract may respond to the API call by executing a process to perform a function within the tree tracking system, and the function may include storing a transaction record on the blockchain that records the request or results to the blockchain. This, in some cases, may include calculating a cryptographic hash value (or values) based on the request or the results and a cryptographic hash value of one or more other transaction records in the blockchain by which the results were determined. In some cases, a new entry (e.g., a new transaction record, which may correspond to the establishment of a tree record, generation of a tree token, transfer of a tree token to a user account, or other function described herein) created by the smart contract may include this cryptographic hash value and pointers to those other nodes. In some cases, such as for the other transactions records in the blockchain by which the results were determined, the transaction record may include in association with the cryptographic hash value or pointer an indication of which arguments or other criteria were satisfied according to that transaction record to arrive at the results.

In embodiments where the tree record information is stored on-blockchain, the request 302 may reference a tree record by address in the data store, by which the tree properties and ownership information may be obtained 305. For example, accessing the record, the record including a verified set of information in a unified schema which may correspond to inputs for token generation. In some embodiments, the process may obtain, with one or more processors, information associated with the tree, the information comprising a plurality of properties of the tree and ownership information corresponding to the tree. In some embodiments, a tree record may be consider valid, such as based on transaction information indicative of its generation in accordance with a process like that described in FIG. 2 (e.g., by an application server or smart contract) and which may be verified based on a signature attesting to the validity of the record.

Embodiments of the process may determine a transaction cost 304 for generating the tree token based on the obtained data 305. Some embodiments of the process may determine, with one or more processors, a cost for effecting a transaction to generate a unique token having a correspondence to the tree, the unique token being tracked within a tamper-evident decentralized data store. In some embodiments, a cost is specified in the smart contract or by the application server to generate the tree token.

In some embodiments, the process 300A includes verifying requirements 308 for executing the requested transaction. For example, requirement verification 308 may include determining whether transaction fees 307 are available for processing the transaction. This may include checking that a balance of a wallet associated with the entity requesting the transaction has available funds to cover the transaction costs determined at block 304. In some embodiments, the process may include identifying, with one or more processors, based on the obtained information associated with the tree, values of keys specified by a schema of a smart contract stored within the data store and with which valid unique tokens corresponding to tracked trees are associated.

In some embodiments, requirement and criteria verification 308 may include determining whether the tree record or requesting entity information meets one or more requirement specified criteria for generating a tree token. Thus, for example, if the tree record on-blockchain does not meet one or more requirements specified by a smart contract to generate a tree token, the process 300 may determine 310, with one or more processors, to reject 314 the request. In this way, on-blockchain operations may be avoided if the tree record of requesting entity information does not meet requirements for tree token generation. The one or more requirements may be specified in a uniform schema such as to afford comparison with tree record or owner information stored on-blockchain and required requesting entity information (e.g., for verification of the requesting entity as the tree owner) according to the data structure specified by the unified schema.

In some embodiments, the process 300A includes determining 310 with one or more processors, whether to execute the requested transaction based on the result of the requirement verification at step 308. If the requirements are not verified, the request may be rejected 314. The rejection may specify the requirements not met during verification. If the requirement are verified, the request may be effected as a transaction in blockchain 312 to enumerate the generation of a new tree token. For example, the transaction fees 307 verified at step 308 can be utilized to provide the cost for effectuating one or more transactions, or token generation cost to an application server.

In some embodiments, the process at step 312 includes transmitting, with one or more processors, a request to computing nodes of the data store to process the transaction by the smart contract to generate the unique token, transaction information of the transaction comprising a set of input values based on the identified values of keys and an address of the smart contract within the data store. In response to receiving the requested transaction, a computing node associated with the data store obtains computer program code of the smart contract from based on the address and executes the computer program code of the smart contract with one or more processors. Execution of the smart contract to effectuate a requested transaction in the data store may comprise a determination of whether generate the unique token in accordance with the requested transaction based on verification of at least some of the input values and requirements for generating the unique token corresponding to the tree, publishing of one or more records to the data store, the one or more records being indicative of generation of a unique token identifier of the unique token corresponding to the tree and transfer of the unique token to the digital wallet associated with the owner based on verification of criteria of the smart contract. For example, a cryptographic signature of a tree certification authority attesting to the plurality of properties of the tree may be verified. A cryptographic signature of an owner of the tree associated with the ownership information and attesting to the request to tokenize the physical tree or the requested transaction may be verified. And, an availability of funds equal or greater to the determined cost in a digital wallet associated with the owner may be verified. In turn, the computing node may effectuate the transaction and a plurality of computing nodes may reach a result based on consensus.

In some embodiments, the process 300A includes determining, with one or more processors, whether the tree record information obtained at step 305 is verified on the blockchain. If the tree record information is not verified, the transaction may be rejected. Verification may fail as a result of one or more later transactions pertaining to the obtained tree record information stored on the blockchain (e.g., no longer current), or being unable to verify one or more earlier transactions to establish that the tree record has not previously been processed to generate a tree token, or an indication that a generated tree token would otherwise not uniquely correspond to a tree or is uniquely identifiable from other tree tokens. Returning of a result 314 may include an indication of the transfer to the generated tree token to the digital wallet of the requesting entity (or other specified wallet destination for the generated tree token).

FIG. 3B is a flowchart of an example of a process 300B executed by an application server and/or a computing node with a smart contract in accordance with some embodiments of the present techniques. Process 300B may be implemented to determine whether to effectuate a transaction indicative of a processing result (e.g., publish for storage or a corresponding result indicative of the storage) of a tree token to a tamper-evident, immutable, decentralized data store. For example, processing of a tree token may include transferring, by effectuating one or more transactions, ownership of a tree token from one digital wallet to another digital wallet, processing ecological benefits of the tree token, etc. In some cases, the process 300B is executed by one or more computing nodes of a decentralized data store and/or an application server, though embodiments are not limited to that implementation, which is not to suggest that any other description herein is limiting. For example, in some cases an application server may operate as, or include, a computing node, and in some cases, some steps may be performed by an application server and some steps by a computing node executing a smart contract. In some embodiments, the functionality described with respect to FIG. 3B and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 300B includes receiving, with one or more processors, a request 332 to transfer a tree token, which may transfer an instance (e.g., record a change in ownership) of a unique token (e.g., like an ERC-721 token) that corresponds to a physical tree from the digital wallet of one user to another. For example, a tree owner may request the transfer of a tree token corresponding to a physical tree that is owned or managed by the tree owner from the digital wallet of the tree owner to a digital wallet of an account user that adopts the tree (e.g., purchases the tree token). Later, the user of the digital wallet holding the tree token may request a transfer of the tree token to a digital wallet of another user (e.g., a first user purchases a tree token owned by another user). Transfer of the tree token may transfer an indication of the holder of the instance of the transferable representation of a specific physical tree on the platform. In some embodiments, an address of a smart contract may be called with an API call including the information described below. In some embodiments, the smart contract may respond to the API call by executing a transaction on the blockchain that records information to the blockchain. In some embodiments, the smart contract may perform one or more API requests to other entities to retrieve some of the information described below for processing. For example, a request may specify storage locations of some information and the smart contract may be configured to retrieve that data. All or a subset of the information may also be provided in a request.

In some embodiments, an address of a smart contract may be called with an API call (i.e., a request) including request parameters such as the address and one or more values for arguments defined in the schema of the smart contract. The smart contract may perform one or more verifications, such as signature verifications, based on PKI information, where a public key may be associated with different user accounts or certification entities or an application server or user by which information for processing (e.g., as indicated by a request or in a record) may be vetted. The schema may be enforced by the smart contract, such as by rejecting requests with non-conformant inputs, or lacking one or more required inputs, upon failure to verify one or more required cryptographic signatures, or failure to match a cryptographic hash between input data and implicated data (e.g., indicating a discrepancy). In some embodiments, the smart contract may respond to the API call by executing a process to perform a function within the tree tracking system, and the function may include storing a transaction record on the blockchain that records the request or results to the blockchain. This, in some cases, may include calculating a cryptographic hash value (or values) based on the request or the results and a cryptographic hash value of one or more other transaction records in the blockchain by which the results were determined. In some cases, a new entry (e.g., a new transaction record, which may correspond to the establishment of a tree record, generation of a tree token, transfer of a tree token to a user account, or other function described herein) created by the smart contract may include this cryptographic hash value and pointers to those other nodes. In some cases, such as for the other transactions records in the blockchain by which the results were determined, the transaction record may include in association with the cryptographic hash value or pointer an indication of which arguments or other criteria were satisfied according to that transaction record to arrive at the results.

In some embodiments, the process 300B includes determining a transaction cost 334. In some embodiments, a fee is required by computing nodes who are performing one or more operations to process a tree token. Additionally, in some embodiments, a smart contract may enforce the collection and distribution of certain fees associated with the request process, such as portion of an amount of a sale associated with the transfer of a tree token between user accounts being provided to an owner of the physical tree, or to an application server, or other entity. In some examples, different costs of the transaction may be fixed or variable, such as based on a query to a current market pricing (e.g., of carbon credits, or price of processing). For example, aspects of the disclosed embodiments may implement a carbon credit service to compute carbon credits based on carbon sequestered from a single tree. In some embodiments, the carbon sequestration can be computed based on available tree data corresponding to the physical tree to which a tree token corresponds. The carbon credit service may provide for the processing of a tree token to obtain carbon credits for trade in the online marketplace. The amount of carbon credits generated, which may be allocated to the digital wallet of the holder of the tree token, may be based on the properties of the tree that are indicative of an amount of carbon sequestered and an amount of carbon sequestered since a last generation of carbon credits corresponding to the tree token.

In some embodiments, computation of carbon credit and transaction data associated with the trading of carbon credits may be stored in the blockchain-based data repository. In some cases, fungible carbon-credit tokens (e.g., ERC-20 standard-compliant tokens, said standard being incorporated by reference) may be minted (e.g., periodically) and added to wallet accounts of owners of tree tokens based on a tree model, which may model a proportional allocation of credits to a holder of one or more tree tokens based on the proportion of carbon sequestered by the physical trees (e.g., based on an output of the model that takes properties of a trees or trees as input). The tree model may be encoded in a smart contract and may take as inputs properties of the trees corresponding to tree tokens held by respective digital wallets. In some cases, the tree model may, for example, allocate more fungible carbon-credit tokens for a tree with a larger diameter, warmer climate, more rain, more sunlight, during spring, or of a particular type than for a tree with less optimal properties for sequestering carbon. Thus, for example, in some embodiments, the process 300B may comprise calling one or more other smart contracts. In some embodiments, a smart contract may generate a token, like a carbon credit, in association with one or more of the functions described herein. For example, a smart contract may generate a token representative of carbon sequestration model results based on properties of a tree.

Process 300B verifies criteria and requirements 338 associated with the requested transaction, such as transaction or purchase fees 337 corresponding to a transfer of a token, or the availability of carbon credit tokens. Verification of criteria and requirements 338 may include verification of on-block or off-block data by signature verification based on PKI or verification based on one or more cryptographic hashes. Criteria of a transfer of a tree token may be verified based on a signature of an application server having approved the transfer in some examples. In some examples, results may be stored in a transaction record in node content on-chain.

The process may reject a request 346 that fails to meet criteria for a transaction or for calling a smart contract. The process may determine to execute 340 a transaction, such as a transfer, or processing of a carbon credit, for requests that satisfy respective transaction criteria. The transactions may be effectuated in the blockchain 342 by enumeration in one or more records of transaction information that may be interrogated by other entities, or in subsequent verification processes, such as to determine a current owner of a tree token or a duration since a last processing of ecological benefits of a tree corresponding to a tree token, or an update to properties of a tree corresponding to a tree token (e.g., such as by storing an updated tree record with updated properties which reference a prior record back to an original tree record by corresponding addresses, pointers, or transaction identifiers. Returning of a result 344 of the processing may include an indication of a transfer (e.g., of a tree token to a new digital wallet, or distribution of carbon credits to the wallet of a tree owner), and may be ascertained by one or more monitoring computing devices, such as an application server which may monitor for transactions on the data store that implicate tree records or tree tokens.

Some embodiments may execute the above operations on a computer system, such as the computer system of FIG. 4, which is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

Example enumerated embodiments include, but are not limited to:
1. Embodiments of processes for tracking an instance of a physical tree with a unique token instance on a tamper-evident decentralized data store, comprising: receiving, with one or more processors, a request to tokenize a physical tree; obtaining, with one or more processors, information associated with the tree, the information comprising a plurality of properties of the tree and ownership information corresponding to the tree; determining, with one or more processors, a cost for effecting one or more transactions to generate a unique token having a correspondence to the tree, the unique token being tracked within a tamper-evident decentralized data store, wherein determining the cost comprises determining a first subcost for storing a record of the tree in a unified schema and a second subcost for generating the unique token corresponding to the tree; identifying, with one or more processors, based on the obtained information associated with the tree, values of keys specified by the unified schema to which valid records of trees conform; verifying, with one or more processors, at least some of the identified key-value pairings based on requirements for generating the unique token corresponding to the tree by verifying: a cryptographic signature of a tree certification authority attesting to the plurality of properties of the tree, a cryptographic signature of an owner of the tree associated with the ownership information and attesting to the request to tokenize the physical tree, and availability of funds equal or greater to the determined cost in a digital wallet associated with the owner, effectuating, with one or more processors, a first transaction to store the record of the tree within the tamper-evident decentralized data store; and effectuating, with one or more processors, a second transaction indicative of generation of a unique token identifier of the unique token corresponding to the record of the tree and transfer of the unique token to the digital wallet associated with the owner.
2. A further embodiment comprising: encoding the tree record in a standardized format specified by the unified schema, wherein the standardized format comprises key-value pairs that encode extracted parameters of the tree in JavaScript object notation (JSON) or extensible markup language (XML).
3. A further embodiment comprising: verifying the record of the tree has not been tampered with subsequent to their recording in the data store by verifying that the record of the tree is consistent with a set of cryptographic hash values based on the record of the tree, at least some of the cryptographic hash values also being based on other records.
4. A further embodiment comprising: verifying records of transfer of the unique token from generation to a last recorded transfer to a digital wallet have not been tampered with subsequent to recording in the data store by verifying that each record is consistent with a set of cryptographic hash values based on the record, at least some of the cryptographic hash values also being based on other records.
5. A further embodiment wherein: a record of the second transaction indicative of the generation of the unique token comprises a reference to a location of the record of the tree within the data store to which the unique token corresponds.
6. A further embodiment wherein: a 1:1 correspondence of a unique token to a tree record is enforced based on a verification that no other unique token has been generated based on the record of the tree by interrogation of records of the data store that include the reference to the location of the tree record or tokenization of tree records.
7. A further embodiment wherein: an indication of stake may be recorded for a unique token, a plurality of digital wallets storing an indication of respective stakes in the unique token.
8. A further embodiment wherein: the tamper-evident decentralized data store comprises a directed acyclic graph of cryptographic hash pointers; at least some of the cryptographic hash pointers have cryptographic hash values based on content of adjacent nodes of the directed acyclic graph to which the cryptographic hash pointers point; a first subset of nodes of the directed acyclic graph have node content that includes the records of trees; and a second subset of nodes of the directed acyclic graph have node content that includes records of generation or transfer of unique tokens that correspond to respective ones of the records of trees.
9. A further embodiment wherein: the unified schema specifies key-values corresponding to inputs of a smart contract stored within the data store; the unique tokens are generated by the smart contract; and the unique tokens are uniquely associated with the smart contract based on an address of the smart contract.
10. The method of claim 1, wherein the data store comprises a blockchain and the method further comprises: monitoring, by a monitoring computing device, the blockchain for publication of the record of the tree; and responsive to the publication being detected by the monitoring computing device, updating an interface to display a listing indicative of the tree based on data obtained from the record of the tree.
11. A further embodiment wherein the data store comprises a blockchain, and further: monitoring, by a monitoring computing device, the blockchain for publication of the generation of the unique token; and responsive to the publication, listing, by the monitoring computing device, the unique token within a token marketplace.
12. An embodiment of a process for tracking an instance of a physical tree with a unique token instance on a tamper-evident decentralized data store, comprising: receiving, with one or more processors, a request to tokenize a physical tree; obtaining, with one or more processors, information associated with the tree, the information comprising a plurality of properties of the tree and ownership information corresponding to the tree; determining, with one or more processors, a cost for effecting a transaction to generate a unique token having a correspondence to the tree, the unique token being tracked within a tamper-evident decentralized data store; identifying, with one or more processors, based on the obtained information associated with the tree, values of keys specified by a schema of a smart contract stored within the data store and with which valid unique tokens corresponding to tracked trees are associated; transmitting, with one or more processors, a request to computing nodes of the data store to process the transaction by the smart contract to generate the unique token, transaction information of the transaction comprising a set of input values based on the identified values of keys and an address of the smart contract within the data store; and wherein, in response to receiving the requested transaction, a computing node associated with the data store obtains computer program code of the smart contract from based on the address and executes the computer program code of the smart contract with one or more processors to: determine whether generate the unique token in accordance with the requested transaction based on verification of at least some of the input values and requirements for generating the unique token corresponding to the tree; and publish one or more records to the data store, the one or more records being indicative of generation of a unique token identifier of the unique token corresponding to the tree and transfer of the unique token to the digital wallet associated with the owner based on the verification of: a cryptographic signature of a tree certification authority attesting to the plurality of properties of the tree, a cryptographic signature of an owner of the tree associated with the ownership information and attesting to the request to tokenize the physical tree or the requested transaction, and availability of funds equal or greater to the determined cost in a digital wallet associated with the owner.
13. A further embodiment comprising: encoding the set of input values of the transaction in a standardized format specified by the schema of the smart contract, wherein the standardized format comprises key-value pairs that encode extracted parameters of the tree and ownership information of the tree in JavaScript object notation (JSON) or extensible markup language (XML).
14. A further embodiment comprising: verifying records of transfer of the unique token from generation to a last recorded transfer to a digital wallet have not been tampered with subsequent to recording in the data store by verifying that each record is consistent with a set of cryptographic hash values based on the record, at least some of the cryptographic hash values also being based on other records.
15. A further embodiment wherein a record indicative of the generation of the unique token identifier comprises information about the unique token, the information including properties of the tree to which the unique token corresponds in a standardized tree-token format.
16. A further embodiment wherein the smart contract enforces a 1:1 correspondence of a unique token to a tree based on a verification that no other unique token has been generated for the tree by interrogation of records of previously generated tokens in the data store for one or more key-values specified by the schema of the smart contract that uniquely identify the tree.
17. A further embodiment wherein: the tamper-evident decentralized data store comprises a directed acyclic graph of cryptographic hash pointers; at least some of the cryptographic hash pointers have cryptographic hash values based on content of adjacent nodes of the directed acyclic graph to which the cryptographic hash pointers point; a first subset of nodes of the directed acyclic graph have node content that includes the records of generation of unique tokens corresponding to respective individual physical trees; and a second subset of nodes of the directed acyclic graph have node content that includes records of transfer of the unique tokens between digital wallets of users.
18. An embodiment of a process for establishing a record of tree within a tamper-evident, decentralized data store, comprising: receiving, with one or more processors, a request to establish a tree record, the request comprising data corresponding to a tree, a cryptographic signature of the data corresponding to the tree, and a first public key of a first cryptographic key pair by which the data was signed; determining, with one or more processors, whether to establish a tree record for the tree based on a correspondence of the first public key to a registered tree certification authority and a verification of the cryptographic signature based on the first public key and the data corresponding to the tree; in response to determining to establish the tree record, publishing, to a tamper-evident, decentralized data store, the tree record, the tree record comprising at least a plurality of tree properties represented in the data corresponding to the tree, the data store comprising a plurality of tree records established for respective trees and a plurality of other records; receiving, with one or more processors, a request to tokenize the tree record, the request comprising data corresponding to ownership of the tree, a cryptographic signature of the data corresponding to ownership of the tree, and a second public key of a second cryptographic key pair by which the data was signed; determining, with one or more processors, whether to generate a unique tree token corresponding to the established tree record by which an indication of stake in the tree record is conveyed among users of the data store based on a correspondence of the second public key to a registered owner of the tree and a verification of the cryptographic signature based on the second public key and the data corresponding to ownership of the tree; and in response to determining to generate the unique tree token, publishing, to a tamper-evident, decentralized data store, a unique identifier of a new tree token, an association of the unique identifier of the new tree token with the established tree record, and an indication of transfer of the new tree token to an address associated with a digital wallet of the owner.
19. A further embodiment comprising: verifying the tree record has not been tampered with subsequent to publishing by verifying that the tree record is consistent with a set of cryptographic hash values based on the tree record, at least some of the cryptographic hash values also being based on other records; and verifying records of transfer of the tree token from generation to a last transfer to a digital wallet have not been tampered with subsequent to publishing by verifying that each record is consistent with a set of cryptographic hash values based on the record, at least some of the cryptographic hash values also being based on other records.
20. A further embodiment comprising: transferring the tree token from a first digital wallet to a second digit wallet responsive to the verifying.

What is claimed is:

1. A computer-implemented method of tracking an instance of a physical tree with a unique token instance on a tamper-evident decentralized data store, the method comprising:
receiving, with one or more processors, a request to tokenize a physical tree;
obtaining, with one or more processors, information associated with the tree, the information comprising a plurality of properties of the tree and ownership information corresponding to the tree;
determining, with one or more processors, a cost for effecting one or more transactions to generate a unique token having a correspondence to the tree, the unique token being tracked within a tamper-evident decentralized data store, wherein determining the cost comprises determining a first subcost for storing a record of the tree in a unified schema and a second subcost for generating the unique token corresponding to the tree;
identifying, with one or more processors, based on the obtained information associated with the tree, values of keys specified by the unified schema to which valid records of trees conform;
verifying, with one or more processors, at least some of the identified key-value pairings based on requirements for generating the unique token corresponding to the tree by verifying:
a cryptographic signature of a tree certification authority attesting to the plurality of properties of the tree,
a cryptographic signature of an owner of the tree associated with the ownership information and attesting to the request to tokenize the physical tree, and
availability of funds equal or greater to the determined cost in a digital wallet associated with the owner,
effectuating, with one or more processors, a first transaction to store the record of the tree within the tamper-evident decentralized data store; and
effectuating, with one or more processors, a second transaction indicative of generation of a unique token identifier of the unique token corresponding to the record of the tree and transfer of the unique token to the digital wallet associated with the owner.

2. The method of claim 1, further comprising:
encoding the tree record in a standardized format specified by the unified schema, wherein the standardized format comprises key-value pairs that encode extracted parameters of the tree in JavaScript object notation (JSON) or extensible markup language (XML).

3. The method of claim 1, further comprising:
verifying the record of the tree has not been tampered with subsequent to their recording in the data store by verifying that the record of the tree is consistent with a set of cryptographic hash values based on the record of the tree, at least some of the cryptographic hash values also being based on other records.

4. The method of claim 1, further comprising:
verifying records of transfer of the unique token from generation to a last recorded transfer to a digital wallet have not been tampered with subsequent to recording in the data store by verifying that each record is consistent with a set of cryptographic hash values based on the record, at least some of the cryptographic hash values also being based on other records.

5. The method of claim 1, wherein:
a record of the second transaction indicative of the generation of the unique token comprises a reference to a location of the record of the tree within the data store to which the unique token corresponds.

6. The method of claim 5, wherein:
a 1:1 correspondence of a unique token to a tree record is enforced based on a verification that no other unique token has been generated based on the record of the tree by interrogation of records of the data store that include the reference to the location of the tree record or tokenization of tree records.

7. The method of claim 6, wherein:
an indication of stake may be recorded for a unique token, a plurality of digital wallets storing an indication of respective stakes in the unique token.

8. The method of claim 1, wherein:
the tamper-evident decentralized data store comprises a directed acyclic graph of cryptographic hash pointers;
at least some of the cryptographic hash pointers have cryptographic hash values based on content of adjacent nodes of the directed acyclic graph to which the cryptographic hash pointers point;
a first subset of nodes of the directed acyclic graph have node content that includes the records of trees; and
a second subset of nodes of the directed acyclic graph have node content that includes records of generation or transfer of unique tokens that correspond to respective ones of the records of trees.

9. The method of claim 1, wherein:
the unified schema specifies key-values corresponding to inputs of a smart contract stored within the data store;
the unique tokens are generated by the smart contract; and
the unique tokens are uniquely associated with the smart contract based on an address of the smart contract.

10. The method of claim 1, wherein the data store comprises a blockchain and the method further comprises:
monitoring, by a monitoring computing device, the blockchain for publication of the record of the tree; and
responsive to the publication being detected by the monitoring computing device, updating an interface to display a listing indicative of the tree based on data obtained from the record of the tree.

11. The method of claim 1, wherein the data store comprises a blockchain and the method further comprises:
monitoring, by a monitoring computing device, the blockchain for publication of the generation of the unique token; and
responsive to the publication, listing, by the monitoring computing device, the unique token within a token marketplace.

12. A computer-implemented method of tracking an instance of a physical tree with a unique token instance on a tamper-evident decentralized data store, the method comprising:
receiving, with one or more processors, a request to tokenize a physical tree;
obtaining, with one or more processors, information associated with the tree, the information comprising a plurality of properties of the tree and ownership information corresponding to the tree;
determining, with one or more processors, a cost for effecting a transaction to generate a unique token having a correspondence to the tree, the unique token being tracked within a tamper-evident decentralized data store;
identifying, with one or more processors, based on the obtained information associated with the tree, values of keys specified by a schema of a smart contract stored within the data store and with which valid unique tokens corresponding to tracked trees are associated;
transmitting, with one or more processors, a request to computing nodes of the data store to process the transaction by the smart contract to generate the unique token, transaction information of the transaction comprising a set of input values based on the identified values of keys and an address of the smart contract within the data store; and
wherein, in response to receiving the requested transaction, a computing node associated with the data store obtains computer program code of the smart contract from based on the address and executes the computer program code of the smart contract with one or more processors to:
determine whether generate the unique token in accordance with the requested transaction based on verification of at least some of the input values and requirements for generating the unique token corresponding to the tree; and
publish one or more records to the data store, the one or more records being indicative of generation of a unique token identifier of the unique token corresponding to the tree and transfer of the unique token to the digital wallet associated with the owner based on the verification of:
a cryptographic signature of a tree certification authority attesting to the plurality of properties of the tree,
a cryptographic signature of an owner of the tree associated with the ownership information and attesting to the request to tokenize the physical tree or the requested transaction, and
availability of funds equal or greater to the determined cost in a digital wallet associated with the owner.

13. The method of claim 12, further comprising:
encoding the set of input values of the transaction in a standardized format specified by the schema of the smart contract, wherein the standardized format comprises key-value pairs that encode extracted parameters of the tree and ownership information of the tree in JavaScript object notation (JSON) or extensible markup language (XML).

14. The method of claim 12, further comprising:
verifying records of transfer of the unique token from generation to a last recorded transfer to a digital wallet have not been tampered with subsequent to recording in the data store by verifying that each record is consistent with a set of cryptographic hash values based on the record, at least some of the cryptographic hash values also being based on other records.

15. The method of claim 12, wherein a record indicative of the generation of the unique token identifier comprises information about the unique token, the information including properties of the tree to which the unique token corresponds in a standardized tree-token format.

16. The method of claim 12, wherein the smart contract enforces a 1:1 correspondence of a unique token to a tree based on a verification that no other unique token has been generated for the tree by interrogation of records of previously generated tokens in the data store for one or more key-values specified by the schema of the smart contract that uniquely identify the tree.

17. The method of claim 12, wherein:
the tamper-evident decentralized data store comprises a directed acyclic graph of cryptographic hash pointers;
at least some of the cryptographic hash pointers have cryptographic hash values based on content of adjacent nodes of the directed acyclic graph to which the cryptographic hash pointers point;
a first subset of nodes of the directed acyclic graph have node content that includes the records of generation of unique tokens corresponding to respective individual physical trees; and
a second subset of nodes of the directed acyclic graph have node content that includes records of transfer of the unique tokens between digital wallets of users.

18. A computer-implemented method of establishing a record of tree within a tamper-evident, decentralized data store, the method comprising:
receiving, with one or more processors, a request to establish a tree record, the request comprising data corresponding to a tree, a cryptographic signature of the data corresponding to the tree, and a first public key of a first cryptographic key pair by which the data was signed;
determining, with one or more processors, whether to establish a tree record for the tree based on a correspondence of the first public key to a registered tree certification authority and a verification of the cryptographic signature based on the first public key and the data corresponding to the tree;
in response to determining to establish the tree record, publishing, to a tamper-evident, decentralized data store, the tree record, the tree record comprising at least a plurality of tree properties represented in the data corresponding to the tree, the data store comprising a plurality of tree records established for respective trees and a plurality of other records;
receiving, with one or more processors, a request to tokenize the tree record, the request comprising data corresponding to ownership of the tree, a cryptographic signature of the data corresponding to ownership of the tree, and a second public key of a second cryptographic key pair by which the data was signed;
determining, with one or more processors, whether to generate a unique tree token corresponding to the established tree record by which an indication of stake in the tree record is conveyed among users of the data store based on a correspondence of the second public key to a registered owner of the tree and a verification of the cryptographic signature based on the second public key and the data corresponding to ownership of the tree; and
in response to determining to generate the unique tree token, publishing, to a tamper-evident, decentralized data store, a unique identifier of a new tree token, an association of the unique identifier of the new tree token with the established tree record, and an indication of transfer of the new tree token to an address associated with a digital wallet of the owner.

19. The method of claim 18, further comprising:
verifying the tree record has not been tampered with subsequent to publishing by verifying that the tree record is consistent with a set of cryptographic hash values based on the tree record, at least some of the cryptographic hash values also being based on other records; and
verifying records of transfer of the tree token from generation to a last transfer to a digital wallet have not been tampered with subsequent to publishing by verifying that each record is consistent with a set of cryptographic hash values based on the record, at least some of the cryptographic hash values also being based on other records.

20. The method of claim 19, further comprising:
transferring the tree token from a first digital wallet to a second digit wallet responsive to the verifying.
